(19) United States
(12) Patent Application Publication
(10) Pub. No.: US 2026/0025245 A1
(43) Pub. Date: Jan. 22, 2026

(54) NET ZERO POWER INTERNET OF THINGS REMOTE TAG FINDING

(71) Applicant: QUALCOMM Incorporated, San Diego, CA (US)

(72) Inventors: Yuchul KIM, San Diego, CA (US); Zhikun WU, Beijing (CN); Ahmed ELSHAFIE, San Diego, CA (US); Wei YANG, San Diego, CA (US); Gavin Bernard HORN, La Jolla, CA (US); Peter GAAL, San Diego, CA (US); Francesco PICA, San Diego, CA (US); Sitaramanjaneyulu KANAMARLAPUDI, San Diego, CA (US); Tingfang JI, San Diego, CA (US); Juan MONTOJO, San Diego, CA (US); Olufunmilola Omolade AWONIYI-OTERI, San Diego, CA (US); Linhai HE, San Diego, CA (US); Luis Fernando Brisson LOPES, Swindon (GB); Krishna Kiran MUKKAVILLI, San Diego, CA (US); Wanshi CHEN, San Diego, CA (US); Soo Bum LEE, San Diego, CA (US)

(21) Appl. No.: 18/993,498

(22) PCT Filed: Mar. 14, 2023
(86) PCT No.: PCT/CN2023/081279

§ 371 Date: Jan. 10, 2025

Related U.S. Application Data
(63) Continuation of application No. PCT/CN2022/112305, filed on Aug. 12, 2022.

(30) Foreign Application Priority Data
Aug. 12, 2022 (WO) PCT/CN2022/112305

(51) Int. Cl. H04L 5/00; H02J 50/00; H04W 4/021

(52) U.S. Cl. CPC H04L 5/0048; H02J 50/001; H04W 4/021

(57) ABSTRACT

Systems and techniques are provided for wireless communication. For example, a process can include receiving, at a first device, a trigger signal. The process can further include determining the first device is separated with respect to a second device associated with the first device. The process can further include, based on the determination that the first device is separated, transmitting a response signal to the trigger signal.

### CROSS-REFERENCE TO RELATED APPLICATIONS

This application for Patent is a 371 of international Patent Application PCT/CN2023/081279, filed Mar. 14, 2023, which claims priority to PCT/CN2022/112305, filed Aug. 12, 2022, which are hereby incorporated by referenced in their entirety and for all purposes.

### FIELD

Aspects of the present disclosure generally relate to wireless communications. For example, aspects of the present disclosure relate to finding net zero power internet of things remote tags.

### INTRODUCTION

Wireless communications systems are deployed to provide various telecommunication services, including telephony, video, data, messaging, broadcasts, among others. Wireless communications systems have developed through various generations, including a first-generation analog wireless phone service (1G), a second-generation (2G) digital wireless phone service (including interim 2.5G networks), a third-generation (3G) high speed data, Internet-capable wireless service, a fourth-generation (4G) service (e.g., Long-Term Evolution (LTE), WiMax), and a fifth-generation (5G) service (e.g., New Radio (NR)). There are presently many different types of wireless communications systems in use, including cellular and personal communications service (PCS) systems. Examples of known cellular systems include the cellular Analog Advanced Mobile Phone System (AMPS), and digital cellular systems based on code division multiple access (CDMA), frequency division multiple access (FDMA), time division multiple access (TDMA), the Global System for Mobile communication (GSM), etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

Disclosed are systems, methods, apparatuses, and computer-readable media for performing wireless communication. According to at least one illustrative example, a first device for wireless communication is provided. The first device includes at least one memory and at least one processor coupled to the at least one memory. The at least one processor is configured to: receive a trigger signal; determine the first device is separated with respect to a second device associated with the first device; and based on the determination that the first device is separated, transmit a response signal to the trigger signal.

As another example, a device for wireless communications is provided. The device includes at least one memory; and at least one processor coupled to the at least one memory. The at least one processor is configured to: transmit a trigger signal for a tag device, the trigger signal including an energy signal for harvesting by the tag device; receive a response to the trigger signal; obtain a response signal to the trigger signal from the tag device, the response signal including a service address; and forward at least a portion of the response signal to a device locating service based on the service address in the response signal.

In another example, a method for wireless communications is provided. The method includes: receiving, at a first device, a trigger signal; determining the first device is separated with respect to a second device associated with the first device; and based on the determination that the first device is separated, transmitting a response signal to the trigger signal.

As another example, a method for wireless communications is provided. The method includes: transmitting a trigger signal for a tag device, the trigger signal including an energy signal for harvesting by the tag device; receiving a response to the trigger signal; obtaining a response signal to the trigger signal from the tag device, the response signal including a service address; and forwarding at least a portion of the response signal to a device locating service based on the service address in the response signal.

In another example, a non-transitory computer-readable medium having stored thereon instructions is provided. The instructions, when executed by at least one processor, cause the at least one processor to: receive, at a first device, a trigger signal; determine the first device is separated with respect to a second device associated with the first device; and based on the determination that the first device is separated, transmit a response signal to the trigger signal.

As another example, a non-transitory computer-readable medium having stored thereon instructions is provided. The instructions, when executed by at least one processor, cause the at least one processor to: transmit a trigger signal for a tag device, the trigger signal including an energy signal for harvesting by the tag device: receive a response to the trigger signal; obtain a response signal to the trigger signal from the tag device, the response signal including a service address; and forward at least a portion of the response signal to a device locating service based on the service address in the response signal.

In another example, an apparatus for wireless communications is provided. The apparatus includes: means for receiving, at a first device, a trigger signal; means for determining the first device is separated with respect to a second device associated with the first device; and means for, based on the determination that the first device is separated, transmitting a response signal to the trigger signal.

As another example, an apparatus for wireless communications is provided. The apparatus includes: means for transmitting a trigger signal for a tag device, the trigger signal including an energy signal for harvesting by the tag device: means for receiving a response to the trigger signal; means for obtaining a response signal to the trigger signal from the tag device, the response signal including a service address; and means for forwarding at least a portion of the response signal to a device locating service based on the service address in the response signal.

Aspects generally include a method, apparatus, system, computer program product, non-transitory computer-readable medium, user equipment, base station, wireless communication device, and/or processing system as substantially described herein with reference to and as illustrated by the drawings and specification.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip implementations or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

Other objects and advantages associated with the aspects disclosed herein will be apparent to those skilled in the art based on the accompanying drawings and detailed description. This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

The accompanying drawings are presented to aid in the description of various aspects of the disclosure and are provided solely for illustration of the aspects and not limitation thereof.

FIG. 1 is a block diagram illustrating an example of a wireless communication network, in accordance with some examples;

FIG. 2 is a diagram illustrating a design of a base station and a User Equipment (UE) device that enable transmission and processing of signals exchanged between the UE and the base station, in accordance with some examples:

FIG. 3 is a diagram illustrating an example of a disaggregated base station, in accordance with some examples:

FIG. 4 is a block diagram illustrating components of a user equipment (UE), in accordance with some examples:

FIG. 5 is a diagram illustrating an example of a radio frequency (RF) energy harvesting device, in accordance with some examples:

FIG. 6 is a diagram illustrating an example of small signal operation of a Schottky diode barrier, in accordance with some examples:

FIG. 7A is a diagram illustrating example energy harvesting characteristics between input power and harvested power, in accordance with some examples:

FIG. 7B is a diagram illustrating an example of energy conversion efficiency associated with different frequencies and input powers, in accordance with some examples:

FIG. 8A is a diagram illustrating an example of an environment in which a remote (semi) passive tag positioning is performed, in accordance with some examples:

FIG. 8B is a diagram illustrating an example of an environment in which a remote (semi) passive tag positioning is performed, in accordance with some examples:

FIG. 9 is a diagram illustrating finding a semi passive or passive ZP IoT device, in accordance with aspects of the present disclosure:

FIG. 10 is a diagram illustrating finding an active ZP IoT device, in accordance with aspects of the present disclosure:

FIG. 11 is a flow diagram illustrating an example of a process for wireless communications, in accordance with some examples:

FIG. 12 is a flow diagram illustrating another example of a process for wireless communications, in accordance with some examples; and

FIG. 13 is a block diagram illustrating an example of a computing system, in accordance with some examples.

### DETAILED DESCRIPTION

Certain aspects of this disclosure are provided below for illustration purposes. Alternate aspects may be devised without departing from the scope of the disclosure. Additionally, well-known elements of the disclosure will not be described in detail or will be omitted so as not to obscure the relevant details of the disclosure. Some of the aspects described herein may be applied independently and some of them may be applied in combination as would be apparent to those of skill in the art. In the following description, for the purposes of explanation, specific details are set forth in order to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. It should be understood that various changes may be made in the function and arrangement of elements without departing from the scope of the application as set forth in the appended claims.

Wireless communication networks can be deployed to provide various communication services, such as voice, video, packet data, messaging, broadcast, any combination thereof, or other communication services. A wireless communication network may support both access links and sidelinks for communication between wireless devices. An access link may refer to any communication link between a client device (e.g., a user equipment (UE), a station (STA), or other client device) and a base station (e.g., a 3GPP gNB for 5G/NR, a 3GPP eNB for 4G/LTE, a Wi-Fi access point (AP), or other base station). For example, an access link may support uplink signaling, downlink signaling, connection procedures, etc. An example of an access link is a Uu link or interface (also referred to as an NR-Uu) between a 3GPP gNB and a UE.

In various wireless communication networks, various client devices can be utilized that may be associated with different signaling and communication needs. For example, as 5G networks expand into industrial verticals and the quantity of deployed Internet-of-Things (IoT) devices grows, network service categories such as enhanced Mobile Broadband (eMBB), Ultra Reliable Low Latency Communications (URLLC), and massive Machine Type Communications (mMTC), etc., may be expanded to better support various IoT devices, which can include passive IoT devices, semi-passive IoT devices, etc.

For example, passive IoT devices and semi-passive IoT devices are relatively low-cost UEs that may be used to implement one or more sensing and communication capabilities in an IoT network or deployment. In some examples, passive and/or semi-passive IoT sensors (e.g., devices) can be used to provide sensing capabilities for various processes and use cases, such as asset management, logistics, warehousing, manufacturing, etc. Passive and semi-passive IoT devices can include one or more sensors, a processor or micro-controller, and an energy harvester for generating electrical power from incident downlink radio frequency (RF) signals received at the passive or semi-passive IoT device.

Based on harvesting energy from incident downlink RF signals (e.g., transmitted by a network device such as a base station, gNB, etc.), energy harvesting devices (e.g., such as passive IoT devices, semi-passive IoT devices, etc.) can be provided without an energy storage element and/or can be provided with a relatively small energy storage element (e.g., battery, capacitor, etc.) Energy harvesting devices can be deployed at large scales, based on the simplification in their manufacture and deployment associated with implementing wireless energy harvesting.

In a wireless communication network environment (e.g., cellular network, etc.), a network device (e.g., such as a base station or gNB, etc.) can be used to transmit downlink RF signals to energy harvesting devices. In one illustrative example, a base station or gNB can read and/or write information stored on energy harvesting IoT devices by transmitting the downlink RF signal. A downlink RF signal can provide energy to an energy harvesting IoT device and can be used as the basis for an information-bearing uplink signal transmitted back to the network device by the energy harvesting IoT device (e.g., based on reflecting or backscattering a portion of the incident downlink RF signal). The base station or gNB can read the reflected signal transmitted by an energy harvesting IoT device to decode the information transmitted by the IoT device (e.g., such as sensor information collected by one or more sensors included in the IoT device, etc.).

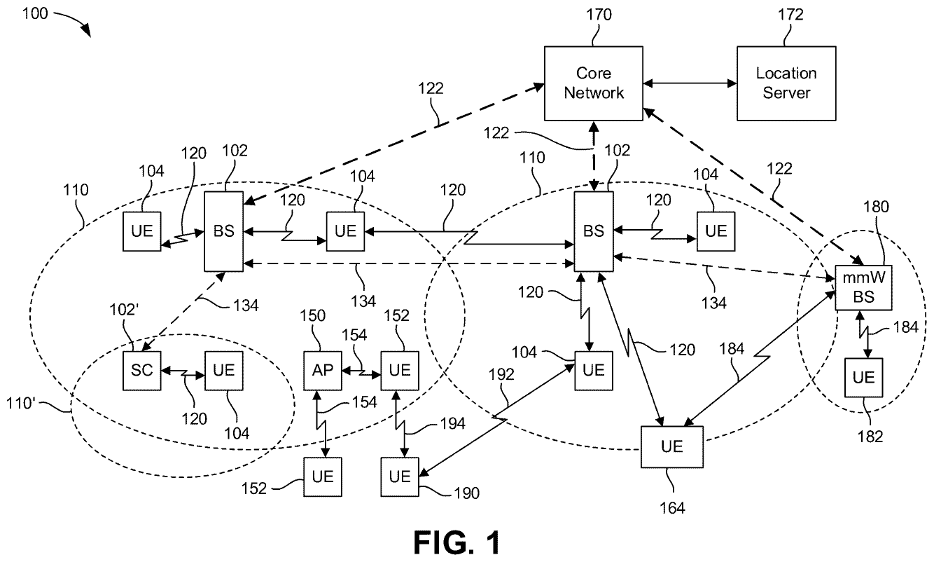

Net zero power IoT (ZP-IoT) devices are devices that rely on energy harvesting and passive communication (also referred to as low power communication) technologies, such as backscatter communications, as shown in FIG. 1A and FIG. 1B. With such technologies, low power and low cost of devices can be achieved. In legacy commercial communication systems, ultra-high frequency radio frequency identification (UHF RFID) systems are mature and widely used all around the world, which is also based on backscatter communication. However, current ultra-high frequency (UHF) RFID systems are not compatible to 5G/NR systems. For instance, such RFID systems are typically configured to operate on the industrial, scientific and medical (ISM) band, while 5G/NR systems are typically configured to operate in licensed band. Further, there is currently no interference defined between those two different systems. Accordingly, a new design for ZP-IoT devices may be useful.

In some examples, for a given downlink signal with a given input RF power received at an energy harvesting device, a first portion of the input RF power is provided to the device's energy harvester (e.g., with a percentage being converted to useful electrical power based on the conversion efficiency of the harvester, and the remaining percentage wasted or dissipated as heat, etc.). A remaining, second portion of the input RF power is available for use in the backscattered uplink transmission (e.g., the second portion of the input power is reflected and modulated with the uplink communication).

In some cases, ZP-IoT devices may be used to located lost/misplaces/separated items by attaching ZP-IoT devices to items that may be lost/misplaced/separated. The ZP-IoT devices improve on existing locating tags by as the ZP-IoT devices may be used without requiring a relatively large power sources, such as a user replaceable or user rechargeable battery.

In some cases, when a ZP-IoT tag device is lost/misplaced/separated, the ZP-IoT tag device may be outside of a wireless communications range of an associated user device. As the ZP-IoT tag device may not be able to directly communicate with the associated user device, a solution to detect and relay a location of the ZP-IoT tag device may be useful.

Systems, apparatuses, processes (also referred to as methods), and computer-readable media (collectively referred to as “systems and techniques”) are described herein that can be used to find ZP-IoT devices. For example, the systems and techniques described herein can be used to provide wireless energy transfer to a ZP-IoT device, determine that the ZP-IoT device has been separated from the associated user device, transmit a response signal from the ZP-IoT device that may be received and relayed to a tag locating service to help allow the ZP-IoT device to be found.

As an example, a wireless node or wireless device may send trigger signals (e.g., a lost tag signal) to help find nearby separated ZP-IoT tag devices. In some cases, the trigger signal may include an energy signal for energizing ZP-IoT tag devices. Upon reception, a ZP-IoT tag device may determine whether it has been separated from the associated user device. If a ZP-IoT tag device determines that it has been separated from the associated user device, the ZP-IoT tag device may transmit a response to the trigger signal. This response to the trigger signal may be received by the nearby wireless node or wireless device. In some cases, location information may be provided by the wireless node or wireless device and this location information, along with information from the response to the trigger signal, may be sent to a device locating service.

Further aspects of the systems and techniques will be described with respect to the figures.

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

As used herein, the terms “user equipment” (UE) and “network entity.” are not intended to be specific or otherwise limited to any particular radio access technology (RAT), unless otherwise noted. In general, a UE may be any wireless communication device (e.g., a mobile phone, router, tablet computer, laptop computer, and/or tracking device, etc.), wearable (e.g., smartwatch, smart-glasses, wearable ring, and/or an extended reality (XR) device such as a virtual reality (VR) headset, an augmented reality (AR) headset or glasses, or a mixed reality (MR) headset), vehicle (e.g., automobile, motorcycle, bicycle, etc.), aircraft (e.g., an airplane, jet, unmanned aerial vehicle (UAV) or drone, helicopter, airship, glider, etc.), and/or Internet of Things (IoT) device, etc., used by a user to communicate over a wireless communications network. A UE may be mobile or may (e.g., at certain times) be stationary, and may communicate with a radio access network (RAN). As used herein, the term “UE” may be referred to interchangeably as an “access terminal” or “AT,” a “client device,” a “wireless device,” a “subscriber device,” a “subscriber terminal,” a “subscriber station,” a “user terminal” or “UT,” a “mobile device,” a “mobile terminal,” a “mobile station,” or variations thereof. Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on IEEE 802.11 communication standards, etc.), and so on.

A network entity can be implemented in an aggregated or monolithic base station architecture, or alternatively, in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. A base station (e.g., with an aggregated/monolithic base station architecture or disaggregated base station architecture) may operate according to one of several RATs in communication with UEs depending on the network in which it is deployed, and may be alternatively referred to as an access point (AP), a network node, a NodeB (NB), an evolved NodeB (eNB), a next generation eNB (ng-eNB), a New Radio (NR) Node B (also referred to as a gNB or gNodeB), etc. A base station may be used primarily to support wireless access by UEs, including supporting data, voice, and/or signaling connections for the supported UEs. In some systems, a base station may provide edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, or a forward traffic channel, etc.). The term traffic channel (TCH), as used herein, can refer to either an uplink, reverse or downlink, and/or a forward traffic channel.

The term “network entity” or “base station” (e.g., with an aggregated/monolithic base station architecture or disaggregated base station architecture) may refer to a single physical transmit receive point (TRP) or to multiple physical TRPs that may or may not be co-located. For example, where the term “network entity” or “base station” refers to a single physical TRP, the physical TRP may be an antenna of the base station corresponding to a cell (or several cell sectors) of the base station. Where the term “network entity” or “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (e.g., a network of spatially separated antennas connected to a common source via a transport medium) or a remote radio head (RRH) (e.g., a remote base station connected to a serving base station). Alternatively, the non-co-located physical TRPs may be the serving base station receiving the measurement report from the UE and a neighbor base station whose reference radio frequency (RF) signals (e.g., or simply “reference signals”) the UE is measuring. Because a TRP is the point from which a base station transmits and receives wireless signals, as used herein, references to transmission from or reception at a base station are to be understood as referring to a particular TRP of the base station.

In some implementations that support positioning of UEs, a network entity or base station may not support wireless access by UEs (e.g., may not support data, voice, and/or signaling connections for UEs), but may instead transmit reference signals to UEs to be measured by the UEs, and/or may receive and measure signals transmitted by the UEs. Such a base station may be referred to as a positioning beacon (e.g., when transmitting signals to UEs) and/or as a location measurement unit (e.g., when receiving and measuring signals from UEs).

As described herein, a node (which may be referred to as a node, a network node, a network entity, or a wireless node) may include, be, or be included in (e.g., be a component of) a base station (e.g., any base station described herein), a UE (e.g., any UE described herein), a network controller, an apparatus, a device, a computing system, an integrated access and backhauling (IAB) node, a distributed unit (DU), a central unit (CU), a remote/radio unit (RU) (which may also be referred to as a remote radio unit (RRU)), and/or another processing entity configured to perform any of the techniques described herein. For example, a network node may be a UE. As another example, a network node may be a base station or network entity. As another example, a first network node may be configured to communicate with a second network node or a third network node. In one aspect of this example, the first network node may be a UE, the second network node may be a base station, and the third network node may be a UE. In another aspect of this example, the first network node may be a UE, the second network node may be a base station, and the third network node may be a base station. In yet other aspects of this example, the first, second, and third network nodes may be different relative to these examples. Similarly, reference to a UE, base station, apparatus, device, computing system, or the like may include disclosure of the UE, base station, apparatus, device, computing system, or the like being a network node. For example, disclosure that a UE is configured to receive information from a base station also discloses that a first network node is configured to receive information from a second network node. Consistent with this disclosure, once a specific example is broadened in accordance with this disclosure (e.g., a UE is configured to receive information from a base station also discloses that a first network node is configured to receive information from a second network node), the broader example of the narrower example may be interpreted in the reverse, but in a broad open-ended way. In the example above where a UE is configured to receive information from a base station also discloses that a first network node is configured to receive information from a second network node, the first network node may refer to a first UE, a first base station, a first apparatus, a first device, a first computing system, a first set of one or more one or more components, a first processing entity, or the like configured to receive the information; and the second network node may refer to a second UE, a second base station, a second apparatus, a second device, a second computing system, a second set of one or more components, a second processing entity, or the like.

As described herein, communication of information (e.g., any information, signal, or the like) may be described in various aspects using different terminology. Disclosure of one communication term includes disclosure of other communication terms. For example, a first network node may be described as being configured to transmit information to a second network node. In this example and consistent with this disclosure, disclosure that the first network node is configured to transmit information to the second network node includes disclosure that the first network node is configured to provide, send, output, communicate, or transmit information to the second network node. Similarly, in this example and consistent with this disclosure, disclosure that the first network node is configured to transmit information to the second network node includes disclosure that the second network node is configured to receive, obtain, or decode the information that is provided, sent, output, communicated, or transmitted by the first network node.

An RF signal comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

Various aspects of the systems and techniques described herein will be discussed below with respect to the figures. According to various aspects, FIG. 1 illustrates an example of a wireless communications system 100. The wireless communications system 100 (e.g., which may also be referred to as a wireless wide area network (WWAN)) can include various base stations 102 and various UEs 104. In some aspects, the base stations 102 may also be referred to as “network entities” or “network nodes.” One or more of the base stations 102 can be implemented in an aggregated or monolithic base station architecture. Additionally, or alternatively, one or more of the base stations 102 can be implemented in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. The base stations 102 can include macro cell base stations (e.g., high power cellular base stations) and/or small cell base stations (e.g., low power cellular base stations). In an aspect, the macro cell base station may include eNBs and/or ng-eNBs where the wireless communications system 100 corresponds to a long-term evolution (LTE) network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or a 5G core (5GC)) through backhaul links 122, and through the core network 170 to one or more location servers 172 (e.g., which may be part of core network 170 or may be external to core network 170). In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC or 5GC) over backhaul links 134, which may be wired and/or wireless.

The base stations 102 may wirelessly communicate with the UEs 104. Each of the base stations 102 may provide communication coverage for a respective geographic coverage area 110. In an aspect, one or more cells may be supported by a base station 102 in each coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), a virtual cell identifier (VCI), a cell global identifier (CGI)) for distinguishing cells operating via the same or a different carrier frequency. In some cases, different cells may be configured according to different protocol types (e.g., machine-type communication (MTC), narrow band IoT (NB-IoT), enhanced mobile broadband (eMBB), or others) that may provide access for different types of UEs. Because a cell is supported by a specific base station, the term “cell” may refer to either or both of the logical communication entity and the base station that supports it, depending on the context. In addition, because a TRP is typically the physical transmission point of a cell, the terms “cell” and “TRP” may be used interchangeably. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ may have a coverage area 110′ that substantially overlaps with the coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (e.g., also referred to as reverse link) transmissions from a UE 104 to a base station 102 and/or downlink (e.g., also referred to as forward link) transmissions from a base station 102 to a UE 104. The communication links 120 may use MIMO antenna technology, including spatial multiplexing, beamforming, and/or transmit diversity. The communication links 120 may be provided using one or more carrier frequencies. Allocation of carriers may be asymmetric with respect to downlink and uplink (e.g., a greater or lesser quantity of carriers may be allocated for downlink than for uplink).

Beamforming, which may also be referred to as spatial filtering, directional transmission, or directional reception, is a signal processing technique that may be used at a transmitting device or a receiving device (e.g., one or more of the base stations 102, UEs 104, etc.) to shape or steer an antenna beam (e.g., a transmit beam, a receive beam) along a spatial path between the transmitting device and the receiving device. Beamforming may be implemented based on combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A transmitting device and/or a receiving device (e.g., such as one or more of base stations 102 and/or UEs 104) may use beam sweeping techniques as part of beam forming operations. For example, a base station 102 (e.g., or other transmitting device) may use multiple antennas or antenna arrays (e.g., antenna panels) to conduct beamforming operations for directional communications with a UE 104 (e.g., or other receiving device). Some signals (e.g., synchronization signals, reference signals, beam selection signals, or other control signals) may be transmitted by base station 102 (or other transmitting device) multiple times in different directions. For example, the base station 102 may transmit a signal according to different beamforming weight sets associated with different directions of transmission. Transmissions in different beam directions may be used to identify (e.g., by a transmitting device, such as a base station 102, or by a receiving device, such as a UE 104) a beam direction for later transmission or reception by the base station 102.

Some signals, such as data signals associated with a particular receiving device, may be transmitted by a base station 102 in a single beam direction (e.g., a direction associated with the receiving device, such as a UE 104). In some examples, the beam direction associated with transmissions along a single beam direction may be determined based on a signal that was transmitted in one or more beam directions. For example, a UE 104 may receive one or more of the signals transmitted by the base station 102 in different directions and may report to the base station 104 an indication of the signal that the UE 104 received with a highest signal quality or an otherwise acceptable signal quality.

In some examples, transmissions by a device (e.g., by a base station 102 or a UE 104) may be performed using multiple beam directions, and the device may use a combination of digital precoding or radio frequency beamforming to generate a combined beam for transmission (e.g., from a base station 102 to a UE 104, from a transmitting device to a receiving device, etc.). The UE 104 may report feedback that indicates precoding weights for one or more beam directions, and the feedback may correspond to a configured number of beams across a system bandwidth or one or more sub-bands. The base station 102 may transmit a reference signal (e.g., a cell-specific reference signal (CRS), a channel state information reference signal (CSI-RS), etc.), which may be precoded or unprecoded. The UE 104 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted in one or more directions by a base station 102, a UE 104 may employ similar techniques for transmitting signals multiple times in different directions (e.g., for identifying a beam direction for subsequent transmission or reception by the UE 104) or for transmitting a signal in a single direction (e.g., for transmitting data to a receiving device).

A receiving device (e.g., a UE 104) may try multiple receive configurations (e.g., directional listening) when receiving various signals from the base station 102, such as synchronization signals, reference signals, beam selection signals, or other control signals. For example, a receiving device may try multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned in a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may further include a WLAN AP 150 in communication with WLAN stations (STAs) 152 via communication links 154 in an unlicensed frequency spectrum (e.g., 5 Gigahertz. (GHz)). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available. In some examples, the wireless communications system 100 can include devices (e.g., UEs, etc.) that communicate with one or more UEs 104, base stations 102, APs 150, etc., utilizing the ultra-wideband (UWB) spectrum. The UWB spectrum can range from 3.1 to 10.5 GHZ.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE and/or 5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a millimeter wave (mmW) base station 180 that may operate in mmW frequencies and/or near mmW frequencies in communication with a UE 182. The mmW base station 180 may be implemented in an aggregated or monolithic base station architecture, or alternatively, in a disaggregated base station architecture (e.g., including one or more of a CU, a DU, a RU, a Near-RT RIC, or a Non-RT RIC). Extremely high frequency (EHF) is part of the RF in the electromagnetic spectrum. EHF has a range of 30 GHz to 300 GHZ and a wavelength between 1 millimeter and 10 millimeters. Radio waves in this band may be referred to as a millimeter wave. Near mmW may extend down to a frequency of 3 GHZ with a wavelength of 100 millimeters. The super high frequency (SHF) band extends between 3 GHZ and 30 GHZ, also referred to as centimeter wave. Communications using the mmW and/or near mmW radio frequency band have high path loss and a relatively short range. The mmW base station 180 and the UE 182 may utilize beamforming (e.g., transmit and/or receive) over an mmW communication link 184 to compensate for the extremely high path loss and short range. Further, it will be appreciated that in alternative configurations, one or more base stations 102 may also transmit using mmW or near mmW and beamforming. Accordingly, it will be appreciated that the foregoing illustrations are merely examples and should not be construed to limit the various aspects disclosed herein.

In some aspects relating to 5G, the frequency spectrum in which wireless network nodes or entities (e.g., base stations 102/180, UEs 104/182) operate is divided into multiple frequency ranges. FR1 (e.g., from 450 to 6,000 Megahertz (MHz)), FR2 (e.g., from 24,250 to 52,600 MHZ), FR3 (e.g., above 52,600 MHZ), and FR4 (e.g., between FR1 and FR2). In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (e.g., whether a PCell or an SCell) corresponds to a carrier frequency and/or component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). In carrier aggregation, the base stations 102 and/or the UEs 104 may use spectrum up to Y MHz (e.g., 5, 10, 15, 20, 100 MHz) bandwidth per carrier up to a total of Yx MHz (e.g., x component carriers) for transmission in each direction. The component carriers may or may not be adjacent to each other on the frequency spectrum. Allocation of carriers may be asymmetric with respect to the downlink and uplink (e.g., a greater or lesser quantity of carriers may be allocated for downlink than for uplink). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (e.g., 40 MHz), compared to that attained by a single 20 MHz carrier.

In order to operate on multiple carrier frequencies, a base station 102 and/or a UE 104 can be equipped with multiple receivers and/or transmitters. For example, a UE 104 may have two receivers, “Receiver 1” and “Receiver 2,” where “Receiver 1” is a multi-band receiver that can be tuned to band (e.g., carrier frequency) ‘X’ or band ‘Y,’ and “Receiver 2” is a one-band receiver tunable to band ‘Z’ only. In this example, if the UE 104 is being served in band ‘X,’ band ‘X’ would be referred to as the PCell or the active carrier frequency, and “Receiver 1” would need to tune from band ‘X’ to band ‘Y’ (e.g., an SCell) in order to measure band ‘Y’ (and vice versa). In contrast, whether the UE 104 is being served in band ‘X’ or band ‘Y,’ because of the separate “Receiver 2,” the UE 104 can measure band ‘Z’ without interrupting the service on band ‘X’ or band ‘Y.’

The wireless communications system 100 may further include a UE 164 that may communicate with a macro cell base station 102 over a communication link 120 and/or the mmW base station 180 over an mmW communication link 184. For example, the macro cell base station 102 may support a PCell and one or more SCells for the UE 164 and the mmW base station 180 may support one or more SCells for the UE 164.

The wireless communications system 100 may further include one or more UEs, such as UE 190, that connects indirectly to one or more communication networks via one or more device-to-device (D2D) peer-to-peer (P2P) links (e.g., referred to as “sidelinks”). In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (e.g., through which UE 190 may indirectly obtain WLAN-based Internet connectivity). In an example, the D2D P2P links 192 and 194 may be supported with any well-known D2D RAT, such as LTE Direct (LTE-D), Wi-Fi Direct (Wi-Fi-D), Bluetooth®, and so on.

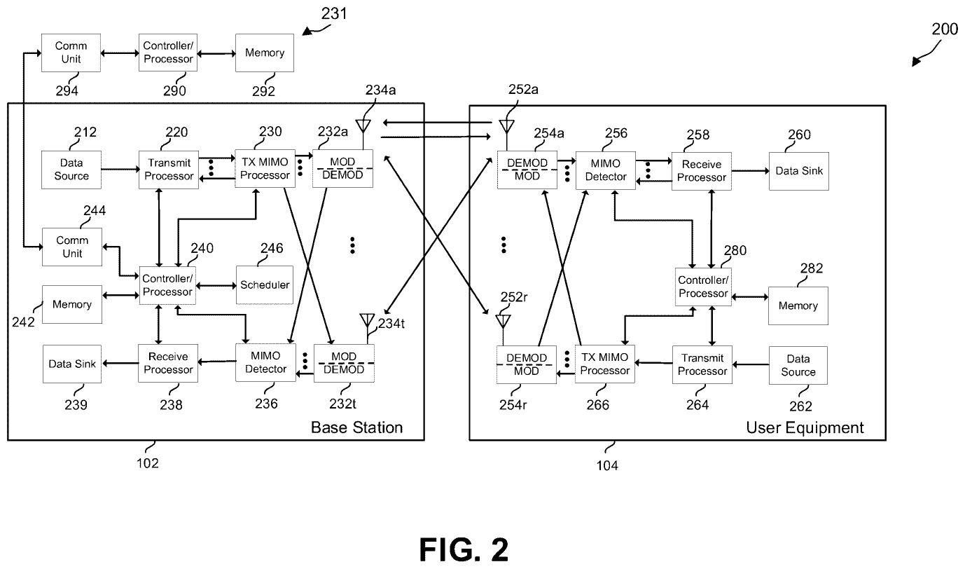

FIG. 2 illustrates a block diagram of an example architecture 200 of a base station 102 and a UE 104 that enables transmission and processing of signals exchanged between the UE and the base station, in accordance with some aspects of the present disclosure. Example architecture 200 includes components of a base station 102 and a UE 104, which may be one of the base stations 102 and one of the UEs 104 illustrated in FIG. 1. Base station 102 may be equipped with T antennas 234a through 234t, and UE 104 may be equipped with R antennas 252a through 252r, where in general T≥1 and R≥1.

At base station 102, a transmit processor 220 may receive data from a data source 212 for one or more UEs, select one or more modulation and coding schemes (MCS) for each UE based on channel quality indicators (CQIs) received from the UE, process (e.g., encode and modulate) the data for each UE based on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., the cell-specific reference signal (CRS)) and synchronization signals (e.g., the primary synchronization signal (PSS) and secondary synchronization signal (SSS)). A transmit (TX) multiple-input multiple-output (MIMO) processor 230) may perform spatial processing (e.g., precoding) on the data symbols, the control symbols, the overhead symbols, and/or the reference symbols, if applicable, and may provide T output symbol streams to T modulators (MODs) 232a through 232t. The modulators 232a through 232t are shown as a combined modulator-demodulator (MOD-DEMOD). In some cases, the modulators and demodulators can be separate components. Each modulator of the modulators 232a to 232t may process a respective output symbol stream (e.g., for an orthogonal frequency-division multiplexing (OFDM) scheme and/or the like) to obtain an output sample stream. Each modulator of the modulators 232a to 232t may further process (e.g., convert to analog, amplify, filter, and upconvert) the output sample stream to obtain a downlink signal. T downlink signals may be transmitted from modulators 232a to 232t via T antennas 234a through 234t, respectively. According to certain aspects described in more detail below, the synchronization signals can be generated with location encoding to convey additional information.

At UE 104, antennas 252a through 252r may receive the downlink signals from base station 102 and/or other base stations and may provide received signals to one or more demodulators (DEMODs) 254a through 254r, respectively. The demodulators 254a through 254r are shown as a combined modulator-demodulator (MOD-DEMOD). In some cases, the modulators and demodulators can be separate components. Each demodulator of the demodulators 254a through 254r may condition (e.g., filter, amplify, downconvert, and digitize) a received signal to obtain input samples. Each demodulator of the demodulators 254a through 254r may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 104 to a data sink 260, and provide decoded control information and system information to a controller/processor 280. A channel processor may determine reference signal received power (RSRP), received signal strength indicator (RSSI), reference signal received quality (RSRQ), channel quality indicator (CQI), and/or the like.

On the uplink, at UE 104, a transmit processor 264 may receive and process data from a data source 262 and control information (e.g., for reports comprising RSRP, RSSI, RSRQ, CQI, and/or the like) from controller/processor 280. Transmit processor 264 may also generate reference symbols for one or more reference signals (e.g., based on a beta value or a set of beta values associated with the one or more reference signals). The symbols from transmit processor 264 may be precoded by a TX-MIMO processor 266, further processed by modulators 254a through 254r (e.g., for DFT-s-OFDM, CP-OFDM, and/or the like), and transmitted to base station 102. At base station 102, the uplink signals from UE 104 and other UEs may be received by antennas 234a through 234t, processed by demodulators 232a through 232t, detected by a MIMO detector 236 (e.g., if applicable), and further processed by a receive processor 238 to obtain decoded data and control information sent by UE 104. Receive processor 238 may provide the decoded data to a data sink 239 and the decoded control information to controller (e.g., processor) 240. Base station 102 may include communication unit 244 and communicate to a network controller 231 via communication unit 244. Network controller 231 may include communication unit 294, controller/processor 290, and memory 292.

In some aspects, one or more components of UE 104 may be included in a housing. Controller 240 of base station 102, controller/processor 280 of UE 104, and/or any other component(s) of FIG. 2 may perform one or more techniques associated with implicit UCI beta value determination for NR.

Memories 242 and 282 may store data and program codes for the base station 102 and the UE 104, respectively. A scheduler 246 may schedule UEs for data transmission on the downlink, uplink, and/or sidelink.

In some aspects, deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (e.g., such as a Node B (NB), evolved NB (eNB), NR BS, 5G NB, access point (AP), a transmit receive point (TRP), or a cell, etc.) may be implemented as an aggregated base station (e.g., also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (e.g., such as one or more central or centralized units (CUs), one or more distributed units (DUs), or one or more radio units (RUS)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (e.g., such as the network configuration sponsored by the O-RAN Alliance)), or a virtualized radio access network (e.g., vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

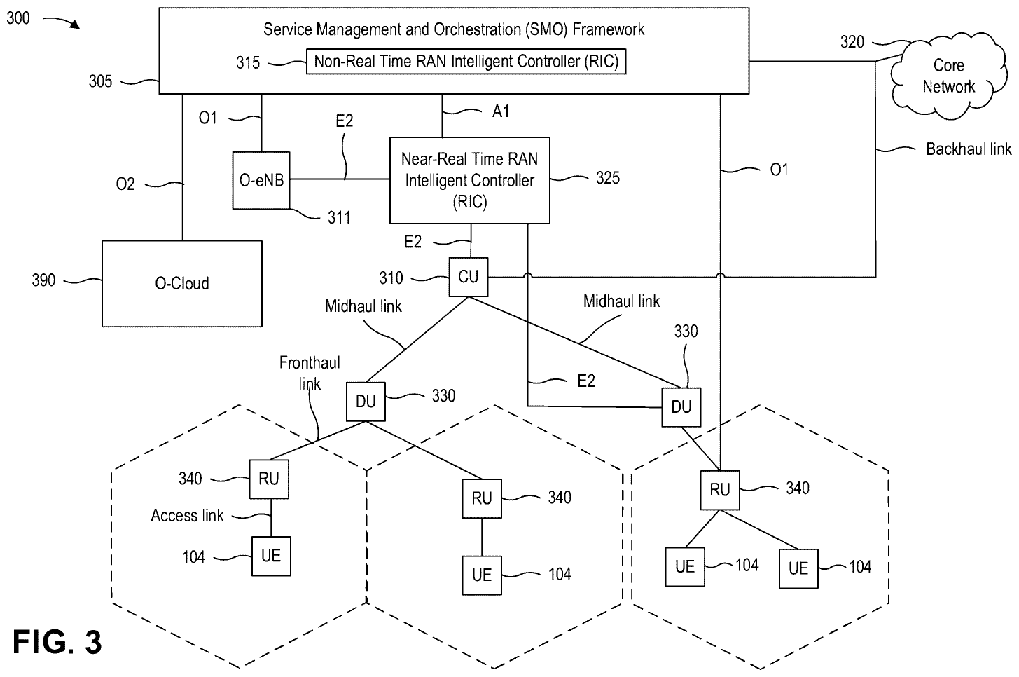

FIG. 3 is a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (e.g., such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUS) 340) via respective fronthaul links. The RUs 340 may communicate with respective UEs 104 via one or more radio frequency (RF) access links. In some implementations, the UE 104 may be simultaneously served by multiple RUs 340.

Each of the units (e.g., the CUS 310, the DUs 330, the RUs 340, as well as the Near-RT RICs 325, the Non-RT RICs 315, and the SMO Framework 305) illustrated in FIG. 3 and/or described herein may include one or more interfaces or be coupled to one or more interfaces configured to receive or transmit signals, data, or information (e.g., collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (e.g., such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (e.g., Central Unit-User Plane (CU-UP)), control plane functionality (e.g., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (e.g., such as modules for forward error correction (FEC) encoding and decoding, scrambling, modulation and demodulation, or the like) depending on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340), controlled by a DU 330, may correspond to a logical node that hosts RF processing functions, or low-PHY layer functions (e.g., such as performing fast Fourier transform (FFT), inverse FFT (iFFT), digital beamforming, physical random-access channel (PRACH) extraction and filtering, or the like), or both, based on the functional split, such as a lower layer functional split. In such an architecture, the RU(s) 340 can be implemented to handle over the air (OTA) communication with one or more UEs 104. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (e.g., such as an O1 interface). For virtualized network elements, the SMO Framework 305 may be configured to interact with a cloud computing platform (e.g., such as an open cloud (O-Cloud) 390) to perform network element life cycle management (e.g., such as to instantiate virtualized network elements) via a cloud computing platform interface (e.g., such as an O2 interface). Such virtualized network elements can include, but are not limited to, CUs 310, DUs 330, RUS 340, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (e.g., such as via an A1 interface) the Near-RT RIC 325. The Near-RT RIC 325 may be configured to include a logical function that enables near-real-time control and optimization of RAN elements and resources via data collection and actions over an interface (e.g., such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (e.g., such as reconfiguration via 01) or via creation of RAN management policies (e.g., such as A1 policies).

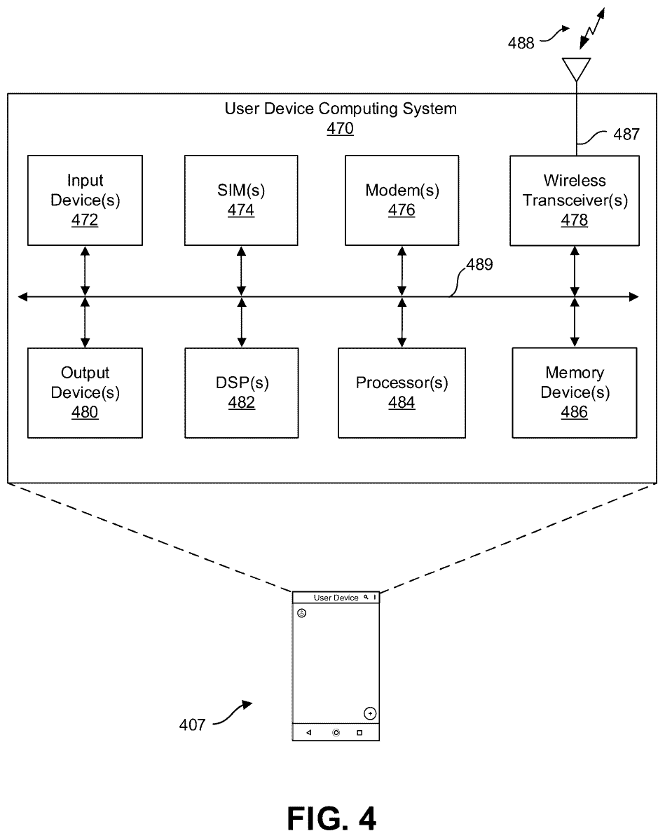

FIG. 4 illustrates an example of a computing system 470 of a wireless device 407. The wireless device 407 may include a client device such as a UE (e.g., UE 104, UE 152, UE 190) or other type of device (e.g., a station (STA) configured to communication using a Wi-Fi interface) that may be used by an end-user. For example, the wireless device 407 may include a mobile phone, router, tablet computer, laptop computer, tracking device, wearable device (e.g., a smart watch, glasses, an extended reality (XR) device such as a virtual reality (VR), augmented reality (AR), or mixed reality (MR) device, etc.), Internet of Things (IoT) device, a vehicle, an aircraft, and/or another device that is configured to communicate over a wireless communications network. The computing system 470 includes software and hardware components that may be electrically or communicatively coupled via a bus 489 (e.g., or may otherwise be in communication, as appropriate). For example, the computing system 470 includes one or more processors 484. The one or more processors 484 may include one or more CPUs, ASICS, FPGAS, APs, GPUs, VPUs, NSPs, microcontrollers, dedicated hardware, any combination thereof, and/or other processing device or system. The bus 489 may be used by the one or more processors 484 to communicate between cores and/or with the one or more memory devices 486.

The computing system 470 may also include one or more memory devices 486, one or more digital signal processors (DSPs) 482, one or more SIMs 474, one or more modems 476, one or more wireless transceivers 478, an antenna 487, one or more input devices 472 (e.g., a camera, a mouse, a keyboard, a touch sensitive screen, a touch pad, a keypad, a microphone, and/or the like), and one or more output devices 480 (e.g., a display, a speaker, a printer, and/or the like).

In some aspects, computing system 470 may include one or more radio frequency (RF) interfaces configured to transmit and/or receive RF signals. In some examples, an RF interface may include components such as modem(s) 476, wireless transceiver(s) 478, and/or antennas 487. The one or more wireless transceivers 478 may transmit and receive wireless signals (e.g., signal 488) via antenna 487 from one or more other devices, such as other wireless devices, network devices (e.g., base stations such as eNBs and/or gNBs, Wi-Fi access points (APs) such as routers, range extenders or the like, etc.), cloud networks, and/or the like. In some examples, the computing system 470 may include multiple antennas or an antenna array that may facilitate simultaneous transmit and receive functionality. Antenna 487 may be an omnidirectional antenna such that radio frequency (RF) signals may be received from and transmitted in all directions. The wireless signal 488 may be transmitted via a wireless network. The wireless network may be any wireless network, such as a cellular or telecommunications network (e.g., 3G, 4G, 5G, etc.), wireless local area network (e.g., a Wi-Fi network), a Bluetooth™ network, and/or other network.

In some examples, the wireless signal 488 may be transmitted directly to other wireless devices using sidelink communications (e.g., using a PC5 interface, using a DSRC interface, etc.). Wireless transceivers 478 may be configured to transmit RF signals for performing sidelink communications via antenna 487 in accordance with one or more transmit power parameters that may be associated with one or more regulation modes. Wireless transceivers 478 may also be configured to receive sidelink communication signals having different signal parameters from other wireless devices.

In some examples, the one or more wireless transceivers 478 may include an RF front end including one or more components, such as an amplifier, a mixer (e.g., also referred to as a signal multiplier) for signal down conversion, a frequency synthesizer (e.g., also referred to as an oscillator) that provides signals to the mixer, a baseband filter, an analog-to-digital converter (ADC), one or more power amplifiers, among other components. The RF front-end may generally handle selection and conversion of the wireless signals 488 into a baseband or intermediate frequency and may convert the RF signals to the digital domain.

In some cases, the computing system 470 may include a coding-decoding device (or CODEC) configured to encode and/or decode data transmitted and/or received using the one or more wireless transceivers 478. In some cases, the computing system 470 may include an encryption-decryption device or component configured to encrypt and/or decrypt data (e.g., according to the AES and/or DES standard) transmitted and/or received by the one or more wireless transceivers 478.

The one or more SIMs 474 may each securely store an international mobile subscriber identity (IMSI) number and related key assigned to the user of the wireless device 407. The IMSI and key may be used to identify and authenticate the subscriber when accessing a network provided by a network service provider or operator associated with the one or more SIMs 474. The one or more modems 476 may modulate one or more signals to encode information for transmission using the one or more wireless transceivers 478. The one or more modems 476 may also demodulate signals received by the one or more wireless transceivers 478 in order to decode the transmitted information. In some examples, the one or more modems 476 may include a Wi-Fi modem, a 4G (or LTE) modem, a 5G (or NR) modem, and/or other types of modems. The one or more modems 476 and the one or more wireless transceivers 478 may be used for communicating data for the one or more SIMs 474.

The computing system 470 may also include (and/or be in communication with) one or more non-transitory machine-readable storage media or storage devices (e.g., one or more memory devices 486), which may include, without limitation, local and/or network accessible storage, a disk drive, a drive array, an optical storage device, a solid-state storage device such as a RAM and/or a ROM, which may be programmable, flash-updateable, and/or the like. Such storage devices may be configured to implement any appropriate data storage, including without limitation, various file systems, database structures, and/or the like.

In various aspects, functions may be stored as one or more computer-program products (e.g., instructions or code) in memory device(s) 486 and executed by the one or more processor(s) 484 and/or the one or more DSPs 482. The computing system 470 may also include software elements (e.g., located within the one or more memory devices 486), including, for example, an operating system, device drivers, executable libraries, and/or other code, such as one or more application programs, which may comprise computer programs implementing the functions provided by various aspects, and/or may be designed to implement methods and/or configure systems, as described herein.

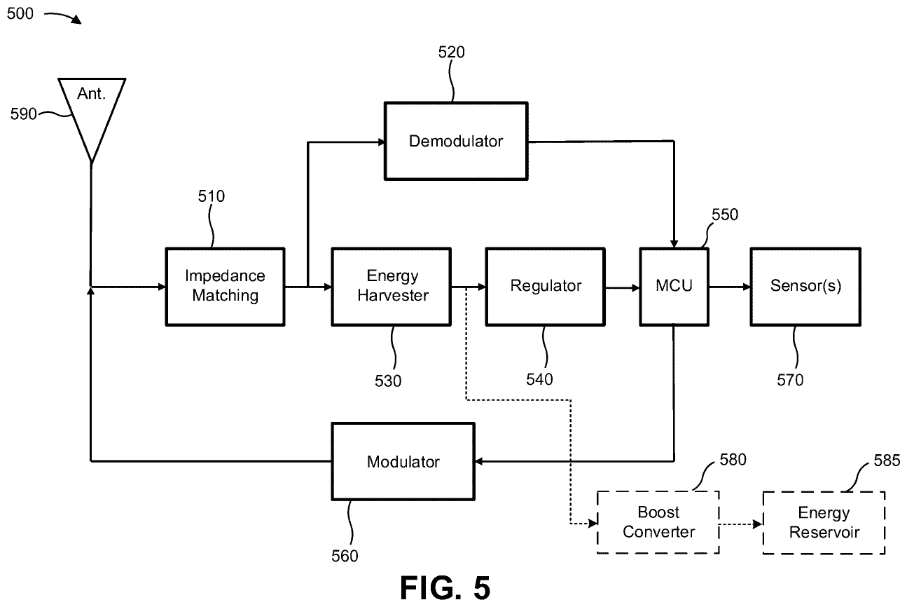

FIG. 5 is a diagram illustrating an example of an architecture of a radio frequency (RF) energy harvesting device 500, in accordance with some examples. As will be described in greater depth below, the RF energy harvesting device 500 can harvest RF energy from one or more RF signals received using an antenna 590. As used herein, the term “energy harvesting” may be used interchangeably with “power harvesting.” In some aspects, an “energy harvesting device” can be a device that is capable of performing energy harvesting (EH). For example, as used herein, the term “energy harvesting device” may be used interchangeably with the term “EH-capable device” or “energy harvesting-capable device.” In some aspects, energy harvesting device 500 can be implemented as an Internet-of-Things (IoT) device, can be implemented as a sensor, etc., as will be described in greater depth below. In other examples, energy harvesting device 500 can be implemented as a Radio-Frequency Identification (RFID) tag or various other RFID devices.

The energy harvesting device 500 includes one or more antennas 590 that can be used to transmit and receive one or more wireless signals. For example, energy harvesting device 500 can use antenna 590 to receive one or more downlink signals and to transmit one or more uplink signals. An impedance matching component 510 can be used to match the impedance of antenna 590 to the impedance of one or more (or all) of the receive components included in energy harvesting device 500. In some examples, the receive components of energy harvesting device 500 can include a demodulator 520 (e.g., for demodulating a received downlink signal), an energy harvester 530 (e.g., for harvesting RF energy from the received downlink signal), a regulator 540, a micro-controller unit (MCU) 550, a modulator 560 (e.g., for generating an uplink signal). In some cases, the receive components of energy harvesting device 500 may further include one or more sensors 570.

The downlink signals can be received from one or more transmitters. For example, energy harvesting device 500 may receive a downlink signal from a network node or network entity that is included in a same wireless network as the energy harvesting device 500. In some cases, the network entity can be a base station, gNB, etc., that communicates with the energy harvesting device 500 using a cellular communication network. For example, the cellular communication network can be implemented according to the 3G, 4G, 5G, and/or other cellular standard (e.g., including future standards such as 6G and beyond).

In some cases, energy harvesting device 500 can be implemented as a passive or semi-passive energy harvesting device, which perform passive uplink communication by modulating and reflecting a downlink signal received via antenna 590. A passive or semi-passive energy harvesting device may also be referred to as a passive or semi-passive EH-capable device, respectively. For example, passive and semi-passive energy harvesting devices may be unable to generate and transmit an uplink signal without first receiving a downlink signal that can be modulated and reflected. In other examples, energy harvesting device 500 may be implemented as an active energy harvesting device, which utilizes a powered transceiver to perform active uplink communication. An active energy harvesting device is able to generate and transmit an uplink signal without first receiving a downlink signal (e.g., by using an on-device power source to energize its powered transceiver).

An active or semi-passive energy harvesting device (e.g., also referred to as an active EH-capable device or a semi-passive EH-capable device, respectively) may include one or more energy storage elements 585 (e.g., collectively referred to as an “energy reservoir”). For example, the one or more energy storage elements 585 can include batteries, capacitors, etc. In some examples, the one or more energy storage elements 585 may be associated with a boost converter 580. The boost converter 580 can receive as input at least a portion of the energy harvested by energy harvester 530 (e.g., with a remaining portion of the harvested energy being provided as instantaneous power for operating the energy harvesting device 500). In some aspects, the boost converter 580 may be a step-up converter that steps up voltage from its input to its output (e.g., and steps down current from its input to its output). In some examples, boost converter 580 can be used to step up the harvested energy generated by energy harvester 530 to a voltage level associated with charging the one or more energy storage elements 585. An active or semi-passive energy harvesting device may include one or more energy storage elements 585 and may include one or more boost converters 580. A quantity of energy storage elements 585 may be the same as or different than a quantity of boost converters 580 included in an active or semi-passive energy harvesting device.

A passive energy harvesting device (e.g., also referred to as a “passive EH-capable device”) does not include an energy storage element 585 or other on-device power source. For example, a passive energy harvesting device may be powered using only RF energy harvested from a downlink signal (e.g., using energy harvester 530). As mentioned previously, a semi-passive energy harvesting device can include one or more energy storage elements 585 and/or other on-device power sources. The energy storage element 585 of a semi-passive energy harvesting device can be used to augment or supplement the RF energy harvested from a downlink signal. In some cases, the energy storage element 585 of a semi-passive energy harvesting device may store insufficient energy to transmit an uplink communication without first receiving a downlink communication (e.g., minimum transmit power of the semi-passive device>capacity of the energy storage element). An active energy harvesting device can include one or more energy storage elements 585 and/or other on-device power sources that can power uplink communication without using supplemental harvested RF energy (e.g., minimum transmit power of the active device<capacity of the energy storage element). The energy storage element(s) 585 included in an active energy harvesting device and/or a semi-passive energy harvesting device can be charged using harvested RF energy.

As mentioned above, passive and semi-passive energy harvesting devices transmit uplink communications by performing backscatter modulation to modulate and reflect a received downlink signal. The received downlink signal is used to provide both electrical power (e.g., to perform demodulation, local processing, and modulation) and a carrier wave for uplink communication (e.g., the reflection of the downlink signal). For example, a portion of the downlink signal will be backscattered as an uplink signal and a remaining portion of the downlinks signal can be used to perform energy harvesting.

Active energy harvesting devices can transmit uplink communications without performing backscatter modulation and without receiving a corresponding downlink signal (e.g., an active energy harvesting device includes an energy storage element to provide electrical power and includes a powered transceiver to generate a carrier wave for an uplink communication). In the absence of a downlink signal, passive and semi-passive energy harvesting devices cannot transmit an uplink signal (e.g., passive communication). Active energy harvesting devices do not depend on receiving a downlink signal in order to transmit an uplink signal and can transmit an uplink signal as desired (e.g., active communication).

In examples in which the energy harvesting device 500 is implemented as a passive or semi-passive energy harvesting device, a continuous carrier wave downlink signal may be received using antenna 590 and modulated (e.g., re-modulated) for uplink communication. In some cases, a modulator 560 can be used to modulate the reflected (e.g., backscattered) portion of the downlink signal. For example, the continuous carrier wave may be a continuous sinusoidal wave (e.g., sine or cosine waveform) and modulator 560 can perform modulation based on varying one or more of the amplitude and the phase of the backscattered reflection. Based on modulating the backscattered reflection, modulator 560 can encode digital symbols (e.g., such as binary symbols or more complex systems of symbols) indicative of an uplink communication or data message. For example, the uplink communication may be indicative of sensor data or other information associated with the one or more sensors 570 included in energy harvesting device 500.

As mentioned previously, impedance matching component 510 can be used to match the impedance of antenna 590 to the receive components of energy harvesting device 500 when receiving the downlink signal (e.g., when receiving the continuous carrier wave). In some examples, during backscatter operation (e.g., when transmitting an uplink signal), modulation can be performed based on intentionally mismatching the antenna input impedance to cause a portion of the incident downlink signal to be scattered back. The phase and amplitude of the backscattered reflection may be determined based on the impedance loading on the antenna 590. Based on varying the antenna impedance (e.g., varying the impedance mismatch between antenna 590 and the remaining components of energy harvesting device 500), digital symbols and/or binary information can be encoded (e.g., modulated) onto the backscattered reflection. Varying the antenna impedance to modulate the phase and/or amplitude of the backscattered reflection can be performed using modulator 560.

As illustrated in FIG. 5, a portion of a downlink signal received using antenna 590 can be provided to a demodulator 520, which performs demodulation and provides a downlink communication (e.g., carried or modulated on the downlink signal) to a micro-controller unit (MCU) 550 or other processor included in the energy harvesting device 500. A remaining portion of the downlink signal received using antenna 590 can be provided to energy harvester 530, which harvests RF energy from the downlink signal. For example, energy harvester 530 can harvest RF energy based on performing AC-to-DC (alternating current-to-direct current) conversion, wherein an AC current is generated from the sinusoidal carrier wave of the downlink signal and the converted DC current is used to power the energy harvesting device 500. In some aspects, energy harvester 530) can include one or more rectifiers for performing AC-to-DC conversion. A rectifier can include one or more diodes or thin-film transistors (TFTs). In one illustrative example, energy harvester 530 can include one or more Schottky diode-based rectifiers. In some cases, energy harvester 530) can include one or more TFT-based rectifiers.

The output of the energy harvester 530 is a DC current generated from (e.g., harvested from) the portion of the downlink signal provided to the energy harvester 530. In some aspects, the DC current output of energy harvester 530 may vary with the input provided to the energy harvester 530. For example, an increase in the input current to energy harvester 530 can be associated with an increase in the output DC current generated by energy harvester 530. In some cases, MCU 550 may be associated with a narrow band of acceptable DC current values. Regulator 540 can be used to remove or otherwise decrease variation(s) in the DC current generated as output by energy harvester 530. For example, regulator 540) can remove or smooth spikes (e.g., increases) in the DC current output by energy harvester 530 (e.g., such that the DC current provided as input to MCU 550 by regulator 540 remains below a first threshold). In some cases, regulator 540) can remove or otherwise compensate for drops or decreases in the DC current output by energy harvester 530 (e.g., such that the DC current provided as input to MCU 550 by regulator 540) remains above a second threshold).

In some aspects, the harvested DC current (e.g., generated by energy harvester 530 and regulated upward or downward as needed by regulator 540) can be used to power MCU 550 and one or more additional components included in the energy harvesting device 500. For example, the harvested DC current can additionally be used to power one or more (or all) of the impedance matching component 510, demodulator 520, regulator 540), MCU 550, sensors 570, modulator 560, etc. For example, sensors 570) and modulator 560 can receive at least a portion of the harvested DC current that remains after MCU 550 (e.g., that is not consumed by MCU 550). In some cases, the harvested DC current output by regulator 540 can be provided to MCU 550, modulator 560, and sensors 570 in series, in parallel, or a combination thereof.

In some examples, sensors 570 can be used to obtain sensor data (e.g., such as sensor data associated with an environment in which the energy harvesting device 500 is located). Sensors 570 can include one or more sensors, which may be of a same or different type(s). In some aspects, one or more (or all) of the sensors 570 can be configured to obtain sensor data based on control information included in a downlink signal received using antenna 590. For example, one or more of the sensors 570 can be configured based on a downlink communication obtained based on demodulating a received downlink signal using demodulator 520. In one illustrative example, sensor data can be transmitted based on using modulator 560 to modulate (e.g., vary one or more of amplitude and/or phase of) a backscatter reflection of the continuous carrier wave received at antenna 590. Based on modulating the backscattered reflection, modulator 560 can encode digital symbols (e.g., such as binary symbols or more complex systems of symbols) indicative of an uplink communication or data message. In some examples, modulator 560 can generate an uplink, backscatter modulated signal based on receiving sensor data directly from sensors 570. In some examples, modulator 560 can generate an uplink, backscatter modulated signal based on received sensor data from MCU 550 (e.g., based on MCU 550 receiving sensor data directly from sensors 570).

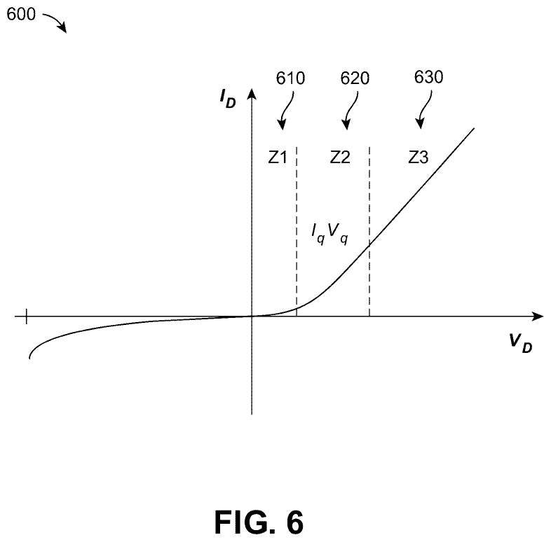

FIG. 6 is a diagram 600 illustrating an example of a small signal rectification operation that may be associated with performing energy harvesting, in accordance with some examples. In one illustrative example, the small signal rectification operation may be a small signal rectification operation associated with a Schottky diode barrier (e.g., a Schottky diode used to perform rectification associated with energy harvester 530 illustrated in FIG. 5).

In some cases, the rectification process in a diode barrier (e.g., Schottky diode or other diode) associated with performing energy harvesting can be classified into small signal operation and large signal operation. For example, large signal operation is associated with rectifying an input signal (e.g., a received downlink signal at an energy harvesting device that includes the diode) having a relatively large amplitude signal that causes the diode to operate in its resistive zone. Small signal operation (e.g., such as the example small signal operation illustrated in FIG. 6) can be associated with rectifying an input signal (e.g., or portion thereof) having a relatively small amplitude signal, such that the diode does not operate in its resistive zone.

For example, small signal operation of a rectifying process in a Schottky diode barrier may be associated with three different operating zones, as depicted in FIG. 6. In a first operating zone 610, the diode behavior may be approximated as quadratic. For example, in the first operating zone 610, the output signal of the diode may be proportional to the square of the input signal to the diode. In some cases, the first operating zone 610 may also be referred to as a square law zone. In a second operating zone 620, the diode behavior may become more affected by other contributions, and the relationship between the output-input signal of the diode may decrease from quadratic towards linear. In some cases, the second operating zone 620 may also be referred to as a transition zone. In a third operating zone 630, the output signal of the diode may be proportional to the input signal to the diode (e.g., a linear relationship between input and output signals of the diode) and no DC component is generated. The third operating zone 630 may also be referred to as a resistive zone.

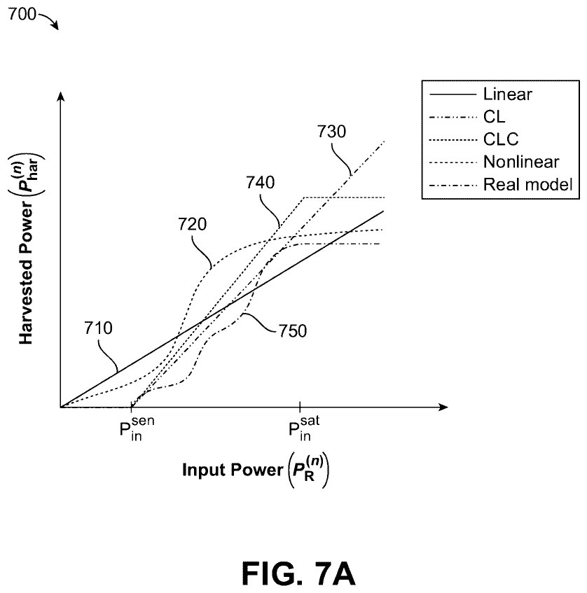

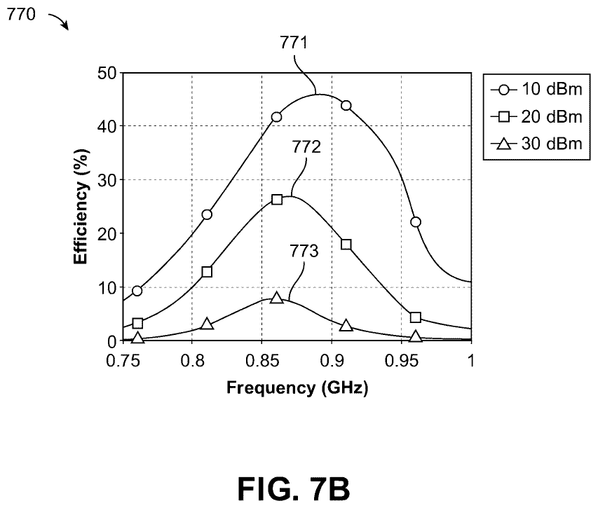

FIG. 7A is a diagram 700 illustrating examples of input power-harvested power conversion models that may be associated with various energy harvesting devices (e.g., such as the energy harvesting device 500 illustrated in the example of FIG. 5, above). Diagram 700 includes a first power conversion model 710, a second power conversion model 720, a third power conversion model 730, a fourth power conversion model 740, and a fifth power conversion model 750. In some aspects, different energy harvesting devices may be associated with different models between input power (e.g., the total RF energy or power of the portion of the received downlink signal provided to energy harvester 530 illustrated in FIG. 5) and harvested power (e.g., the RF energy or power that is harvested and output by energy harvester 530). In some aspects, the power conversion models 710-750 may be associated with passive, semi-passive, and/or active energy harvesting devices.

The first power conversion model 710 can be associated with a first type or category of energy harvesting devices. For example, energy harvesting devices having the first power conversion model 710 can provide harvested power as a continuous, linear, increasing function of the input RF power.

The second power conversion model 720 can be associated with a second type or category of energy harvesting devices. For example, energy harvesting devices having the second power conversion model 720 can provide harvested power as a continuous, non-linear, increasing function of the input RF power.

The third power conversion model 730 can be associated with a third type or category of energy harvesting device. For example, energy harvesting devices having the third power conversion model 730 can provide harvested power that is a continuous, linear, increasing function of the input RF power, given that the input RF power is above a sensitivity threshold

$$( {P}_{in}^{sen} ) .$$

The sensitivity threshold

$${P}_{in}^{sen}$$

can represent a minimum input RF power for which the energy harvesting device is able to perform harvesting (e.g., is able to harvest a non-zero amount of power). When the input RF power is below the sensitivity threshold

$$( {P}_{in}^{sen} ) ,$$

the harvested power is zero.

The fourth power conversion model 740 can be associated with a fourth type or category of energy harvesting device. For example, energy harvesting devices having the fourth power conversion model 740 can provide harvested power that is a continuous, linear, increasing function of the input RF power, given that the input RF power is both above the sensitivity threshold

$${P}_{in}^{sen}$$

and is below a saturation threshold

$${P}_{in}^{sat} .$$

As illustrated, the saturation threshold Pᵢₙ^{sat} is greater than the sensitivity threshold pᵢₙ^{sen}. When the input RF power is below the sensitivity threshold

$${P}_{in}^{sen} ,$$

the harvested power is zero. When the input RF power is above the saturation threshold

$${P}_{in}^{sat} ,$$

the harvested power output saturates (e.g., remains approximately constant for any input RF power above the saturation threshold).

The fifth power conversion model 750 can be associated with a fifth type or category of energy harvesting device. For example, for an input RF power between the sensitivity threshold

$${P}_{in}^{sen}$$

and the saturation threshold

$${P}_{in}^{sat} ,$$

energy harvesting devices having the fifth power conversion model 750 can provide harvested power that is a continuous, non-linear, increasing function of the input RF power.

In some examples, an efficiency of an energy harvesting device can be determined as a percentage of the input RF power that is converted into harvested power. FIG. 7B is a diagram 770 illustrating an example of energy conversion efficiency vs. frequency (e.g., of an input waveform to the energy harvesting device) for different input powers. For example, a first efficiency-frequency relationship 771 is shown for an input RF power of −10 dBm (decibel milliwatts), a second efficiency-frequency relationship 772 is shown for an input RF power of −20 dBm, and a third efficiency-frequency relationship 773 is shown for an input RF power of −30 dBm.

The three efficiency-frequency relationships 771, 772, 773 depicted in FIG. 7B may each be associated with an optimum operating frequency, or an optimum operating frequency band, for which the energy conversion efficiency of a corresponding energy harvesting device is maximized. For example, for an input RF power of −30 dBm, an energy harvesting device with the third energy conversion model 773 may maximize its energy conversion efficiency with an input RF waveform centered at a frequency of 0.86 GHz. In another example, for an input RF power of −20 dBm, an energy harvesting device with the second energy conversion model 772 may maximize its energy conversion efficiency with an input RF waveform centered at a frequency of 0.87 GHz. In another example, for an input RF power of −10 dBm, an energy harvesting device with the first energy conversion model 771 may maximize its energy conversion efficiency with an input RF waveform centered at a frequency of 0.89 GHZ.

In some aspects, the efficiency of an energy harvesting device may vary based on the input RF power (e.g., the RF power of the downlink signal received at an antenna of the energy harvesting device) and the center frequency of the input RF waveform. For example, as illustrated in FIG. 7B, the maximum or peak efficiency of an energy harvesting device that receives a relatively low input RF power may be less than the maximum or peak efficiency of an energy harvesting device that receives a relatively high input RF power (e.g., at −30 dBm the peak efficiency of energy conversion model 773 is below 10%, at −20 dBm the peak efficiency of energy conversion model 772 is approximately 25%, and at −10 dBm the peak efficiency of energy conversion model 771 is approximately 45%). In some cases, conversion efficiency can decrease for frequencies that are greater than the optimum input center frequency and can decrease for frequencies that are less than the optimum input center frequency.

In some aspects, the conversion efficiency of an energy harvesting device may be associated with one or more energy conversion characteristics (e.g., also referred to as energy harvesting characteristics). For example, one or more characteristics may be indicative of a relationship between the conversion efficiency of an energy harvesting device and input frequency. In one illustrative example, an energy harvesting device may have an approximately constant conversion efficiency over a narrowband operating bandwidth. In such examples, the energy harvesting device can receive RF energy from a multi-sine downlink wave with uniform power distribution. In another illustrative example, an energy harvesting device with a wideband operating bandwidth may have a conversion efficiency that is a non-linear function of input frequency over the wideband. A wideband bandwidth can be larger than a narrow band bandwidth. In such examples, the energy harvesting device may receive RF energy based on Gaussian and/or raised-cosine filters being used in combination with (e.g., on top of) the multi-sine downlink wave described above for narrow band operating bandwidths. In some aspects, a wideband bandwidth can be an operating bandwidth (e.g., message bandwidth) of a communication channel that is greater than a coherence bandwidth of the channel.

In some aspects, the energy conversion efficiency of an energy harvesting device may vary continuously with the input RF power. For example, the energy conversion efficiency may be zero for input powers less than the sensitivity threshold

$$( {P}_{in}^{sen} )$$

(e.g., based on the harvested power being equal to zero when the input RF power is below the sensitivity threshold, and conversion efficiency=harvested power/input RF power). In some examples, the energy conversion efficiency of an energy harvesting device may vary over different input frequencies (e.g., as described above with respect to FIG. 7B) and may additionally vary over different input RF powers. For example, in some cases the energy conversion efficiency of an energy harvesting device may be approximately linear with input RF power, for input RF power values between the sensitivity threshold

$$( {P}_{in}^{sen} )$$

and a first input Kr power value greater than

$${P}_{in}^{sen} .$$

the energy conversion efficiency may increase linearly with the input RF power from and above

$${P}_{in}^{sen} .$$

At input Kr powers beyond the linear conversion efficiency zone, the energy conversion efficiency of the energy harvesting device may increase and/or decrease non-linearly with further increases in input RF power. In some examples, the energy conversion efficiency may include one or more additional zones of linear increase (e.g., and/or linear decrease) with input RF power, in addition to an initial linear conversion efficiency zone beginning at the sensitivity threshold

$${P}_{in}^{sen} .$$

As mentioned previously, there is a need for systems and techniques that can be used to provide improved wireless energy harvesting and/or backscatter modulation-based communications between an energy harvesting device (e.g., passive, semi-passive, or active IoT device, etc.) and a network node or transmitter (e.g., gNB or base station). There is also a need for systems and techniques that can be used to provide wireless energy harvesting and backscatter modulation-based communications over a greater range than existing RFID-based approaches. For example, passive or semi-passive IoT devices may include one or more sensors and can be utilized to perform tasks such as asset management, logistics tracking, warehousing, manufacturing, etc. In such examples, the passive (or semi-passive) IoT device(s) may often be located at distances greater than 10 meters away from a corresponding base station or transmitter.

One usage scenario for a net zero power IoT (ZP IoT) devices, such as ZP IoT device 802, 852, is that such devices may be used to locate and/or track lost/misplaced items. For example, a first user may attach a ZP IoT tag device to an item that the user owns. When the item and attached tag device are near the user, the tag device may directly communicate with other devices of the user. However, if the item, and attached tag device, is misplaced by the user, a question arises of how the tag device may communicate with the user if the tag device is no longer in communications coverage of other devices of the user.

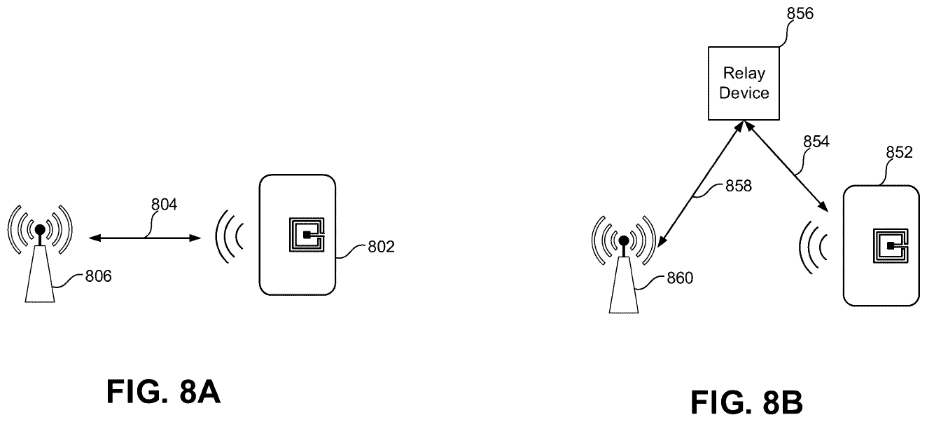

In some cases, a ZP IoT device may utilize wireless energy harvesting techniques and/or backscatter modulation discussed above (hereinafter referred to as “harvested energy”) to collect and store power. This stored power may be used to transmit a signal to a network node or relay device. FIGS. 8A and 8B illustrate example network topologies of ZP IoT devices in a wireless system, in accordance with aspects of the present disclosure. In FIG. 8A, a ZP IoT device 802 may harvest energy and use the harvested energy to communicate 804 with a network node 806 (e.g., gNB or base station). For example, the ZP IoT device 802 may receive UL/DL scheduling in which the ZP IoT device 802 may listen for communications from the network node 806 or transmit data to the network node 806. FIG. 8B includes a ZP IoT device 852, which may or may not be the same ZP IoT device 802 as shown in FIG. 8A. The ZP IoT device 852 in FIG. 8B may communicate 854 with a relay device 856, and the relay device 856 may relay 858 communications from the ZP IoT device 852 to a network node 860, and vice versa. In some cases, the ZP IoT device 852 may communicate 854 with the relay device 856 using a different radio access technology as compared to a radio access technology used by ZP IoT device 802 to communicate with the network node 806. For example, ZP IoT device 852 may use Bluetooth low energy or another low energy communications protocol to communicate with the relay device 856 rather than a cellular protocol, such as 5G NR, LTE, and the like.

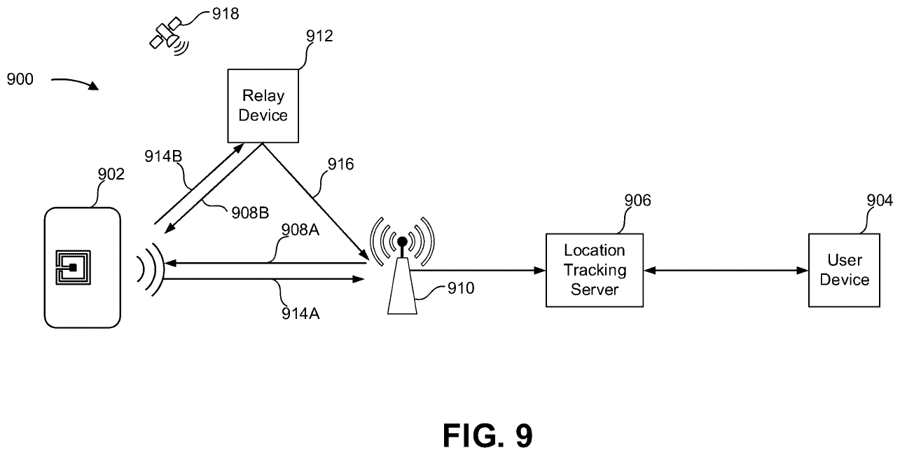

FIG. 9 is a diagram illustrating finding 900 a semi passive or passive ZP IoT device, in accordance with aspects of the present disclosure. In FIG. 9, a ZP IoT tag device 902 (hereinafter tag device 902) may be remote (e.g., attached to a lost/misplaced item) from a user device 904. In some cases, the user device 904 may be any communication device capable of accessing a location tracking server 906. The tag device 902 may be associated with a user device 904. In some cases, this association may be established during a set up procedure of the tag device 902. In FIG. 9, the tag device 902 may be a semi passive or passive (hereinafter referred to as (semi) passive) ZP IoT device.

The (semi) passive ZP IoT device may be a ZP IoT device which itself is not capable of generating a transmission. Rather, the (semi) passive ZP IoT device (e.g., tag device 902) is energized using energy from RF transmissions. In some cases, an energizing and/or triggering transmission may be a dedicated signal. As an example, a dedicated signal may be used for lost tag devices, such as a lost tag signal 908A, 908B (collectively referred to as lost tag signal 908). The dedicated lost tag signal 908 may be transmitted by wireless devices, such as the wireless node 910, relay device 912, or other wireless device and the lost tag signal may include an energy signal for energizing the tag device 902. The (semi) passive ZP IoT device (e.g., tag device 902) may use the energy harvested from the lost tag signal 908 to perform processing, transmitting, and/or receiving tasks. Thus, the tag device 902 may use the lost tag signal 908 to trigger the tag device 902 to perform tasks, such as processing, transmitting, and/or receiving data. In some cases, the lost tag signal 908 may include data/control signal(s), for example, in a data portion of the lost tag signal 908, for tag devices and this data/control portion may be included after, or in conjunction with the energy signal portion of the lost tag signal 908.

In some cases, the dedicated signal, such as the lost tag signal 908, may be periodic, aperiodic, or semi-periodic (e.g., can be activated/deactivated). As examples, if the lost tag signal 908 is periodic, then the lost tag signal 908 may be always transmitted periodically. If the lost tag signal 908 is aperiodic or semi-periodic, then the lost tag signal 908 may be transmitted based on a request, for example, transmitted by a server or the wireless node 910.

In some cases, the dedicated signal may be transmitted via L1, L2, or L3 signaling. In some cases, the dedicated signal may be transmitted by dedicated time/frequency resources, which may be preconfigured for services using ZP IoT devices, such as a tag locating service. In some cases, allocated time/frequency resources may be dynamically configured by a wireless device, such as the wireless node 910, relay device 912, or other wireless device.

As indicated above, in some cases, the lost tag signal 908 may be transmitted by at least a wireless node 910, a relay device 912, or both. In a first example, for a tag locating service, the lost tag signal 908A may be transmitted by the wireless node 910. In some cases, the lost tag signal 908A may be transmitted by all wireless nodes 910 of a wireless network operator which support the tag locating service. In cases where all wireless nodes 910 supporting the tag locating service transmit the lost tag signal 908A, the lost tag signal 908A may be transmitted as a periodic signal in a manner similar to how synchronization signal block (SSB) are transmitted. This periodicity of the lost tag signal 908A may be configured and this configuration may be on a per wireless node 910 basis, per type of wireless node 910, and/or the like.

In some cases, the lost tag signal 908A may be transmitted by a set of wireless nodes 910 of the wireless network operator which support the tag locating service. For example, the set of wireless nodes 910 may be statically configured by the wireless network operator to provide uniform coverage for the tag locating service in an area. As another example, the set of wireless nodes 910 may be dynamically configured. For example, wireless nodes may be dynamically configured to increase a periodicity of the lost tag signal 908A to help track an item more closely. In some cases, this adjustment may be based on a location of the wireless node 910, type of wireless node 910, processing/wireless/memory load on the wireless node 910, and the like. As an example, wireless nodes may be dynamically configured to adjust a periodicity of the lost tag signal 908A based on an area an item is thought to be lost at, a number of responses to the lost tag signal 908A in an area, type of area covered by a particular wireless node 901 (e.g., airport/school/company/etc.), expected density of wireless signals in an area, or the like.

In cases where the lost tag signal 908A is transmitted by the wireless nodes 910, how the lost tag signal 908A is sent may be configured based on one or more parameters for configuring the wireless node 910. In some cases, the one or more parameters may be included in an activation signal sent to wireless nodes 910 to initiate transmitting the lost tag signal 908A. An example of a parameter for configuring the wireless node 910 may include a parameter indicating whether a particular wireless node 910 supports the tag locating service or not or indicating whether the particular wireless node 910 should transmit the lost tag signal 908A. In some cases, the wireless node 910 may transmit the lost tag signal 908A when it is indicated to do so. Another example of parameters for configuring the wireless node 910 may include parameters indicating periodicity and time offset information for the lost tag signal 908A. The periodicity and time offset information may determine how often the lost tag signal 908A may be transmitted as well as a time offset for transmitting based on a reference time. As another example, parameters for configuring the wireless node 910 may indicate frequency, slot/resource block (RB)/band information for transmitting the lost tag signal 908A. Another example of a parameters for configuring the wireless node 910 may include a time duration for transmitting the lost tag signal 908A. For example, where the lost tag signal 908A is semi-statically enabled, the wireless node 910 may be configured to transmit the lost tag signal 908A for the indicated duration. As another example, parameters for configuring the wireless node 910 may include transmit power scale factor of the lost tag signal 908A. For example, the lost tag signal 908A may be boosted by a scale factor (e.g., where OdB means no boosting) and this transmit power scale factor parameter may be used to balance coverage of the lost tag signal 908A and/or to avoid interference with neighboring network nodes.

In a second example, for a tag locating service, the lost tag signal 908B may be transmitted by the relay device 912, such as a UE. In some cases, relay devices 912 which support the tag locating service and which are permitted to (e.g., participating in) transmit the lost tag signal 908B may transmit the lost tag signal 908. In some cases, relay devices 912 which support/participate in the tag locating service may transmit the lost tag signal 908B based on a user setting. For example, users of a UE may decide whether to join a tag locating service and UEs that join may participate in the tag locating service. Such UEs may forward received lost tag responses from nearby tag devices 902 to the tag locating service. In some cases, UEs may be configured whether or not to listen for and/or forward lost tag responses 914 to the location tracking server 906. In some cases, UEs may be configured not to transmit a lost tag signal 908B. In some cases, lost tag signal 908B transmission by a UE may be dynamically configured, for example, by an operating mode of the UE, such as airplane mode, game mode, etc., available battery power, or the like.

In some cases, the lost tag signal 908B may be transmitted by all relay devices 912 which support/participate in the tag locating service transmit the lost tag signal 908B. In cases where all relay devices 912 supporting/participating in the tag locating service, the lost tag signal 908B may be transmitted as a periodic signal in a manner similar to how sidelink primary synchronization signal (SPSS) are transmitted. The periodicity of the lost tag signal 908B may be configured and this configuration may be on a per relay device 912 basis, per type of relay device 912 basis, and/or the like. In some cases, the lost tag signal 908B may be transmitted by all supporting/participating relay devices 912 periodically, for example, based on an activation signal, for example, from a wireless node 910 or server.

In some cases, the lost tag signal 908B may be transmitted by a set of relay devices 912 which support/participate in the tag locating service. For example, the set of supporting/participating relay devices 912 may transmit the lost tag signal 908B periodically in (semi)-static fashion. As another example, the set of supporting/participating relay devices 912 may transmit the lost tag signal 908B periodically based on an activation signal, for example, from a wireless node 910 or server. In some cases, the set of relay devices 912 may be defined based on a location of the relay devices 912, type of relay devices 912, and the like.

In cases where the lost tag signal 908B is transmitted by relay devices 912, how the lost tag signal 908B is sent may be configured based on one or more parameters for configuring the relay devices 912. In some cases, the one or more parameters may be included in the activation signal sent to the relay devices 912. An example of the one or more parameters for configuring the relay devices 912 to send the lost tag signal 980B may include a parameter indicating whether the relay device should transmit the lost tag signal 908B. In some cases, the relay device 912 may transmit the lost tag signal 908B when it is indicated to do so. Another example of the one or more parameters for configuring the relay devices 912 to send the lost tag signal 980B may include parameters indicating a transmission periodicity/time offset information for the lost tag signal 908B. The periodicity and time offset information may determine how often the lost tag signal 908B may be transmitted by relay devices 912 as well as a time offset for transmitting based on a reference time. Another example of the one or more parameters for configuring the relay devices 912 to send the lost tag signal 980B may include parameters indicating a time duration for transmitting the lost tag signal 908B. Another example of the one or more parameters for configuring the relay devices 912 to send the lost tag signal 980B may include parameters indicating frequency, slot/resource block (RB)/band information for transmitting the lost tag signal 908B by the relay devices 912. Another example of the one or more parameters for configuring the relay devices 912 to send the lost tag signal 908B may include parameters indicating a transmit power scale factor of the lost tag signal 908B. For example, the lost tag signal 908B may be boosted by a scale factor (e.g., where 0 dB means no boosting) and this transmit power scale factor parameter may be used to balance coverage of the lost tag signal 908B and/or to avoid interference with neighboring network nodes, other relay devices 912, etc.

Upon receiving the lost tag signal 908, the tag device 902 may determine whether to respond to the lost tag signal. Initially, the tag device 902 may harvest energy for processing the lost tag signal 908 and/or transmitting a lost tag response 914A, 914B (collectively lost tag response 914) based on the lost tag signal 908 sent by the wireless node 910 and/or the relay device 912. In some cases, the tag device 902 may also harvest and/or store energy from signals transmitted by other wireless devices.

In some cases, if the tag device 902 determines to transmit the lost tag response 914 the tag device 902 may transmit the lost tag response 914A to the wireless node 910, and/or transmit a lost tag response 914B to the relay device 912. In some cases, the tag device 902 may determine whether to transmit the lost tag response 914 based on whether the tag device 902 has been separated from another device, such as the user device 904. In some cases, the user device 904 may periodically transmit an owner beacon. In some cases, the owner beacon may include an identifier for the user device 904. In some cases, the user device identifier is unencrypted. The owner beacon may be transmitted by the user device 904 along with energy that may be harvested by the tag device 902. In some cases, the tag device 902 may store timing information indicating when the tag device 902 last received the owner beacon.

The tag device 902 may determine that it has been separated from the user device in a variety of ways. As an example, the tag device 902 may determine that it has been separated (is remote) from the user device 904 if the tag device 902 has not received the owner beacon within a first separation threshold amount of time. In some cases, the tag device 902 may store the user device identifier information during a setup process and the tag device 902 may compare the user device identifier of a received owner beacon to the stored user device identifier to determine if the received owner beacon is associated with the tag device 902. If the tag device 902 has not received the owner beacon within a certain amount of time (e.g., X number of seconds/minutes/hours/days), such as the last hour, the tag device 902 may determine that the tag device 902 has been separated from the user device 904. For example, if the tag device 902 receives a lost tag signal 908, the tag device 902 may compare a current time against the stored timing information indicating when the tag device 902 last received the owner beacon. If the elapsed time exceeds the first separation threshold amount of time, then the tag device 902 may determine that it has been separated from the user device 904. In some cases, the tag device 902 may be associated with multiple user devices 904 (e.g., family devices) and the tag device 902 may compare the user device identifier of a received owner beacon to the associated multiple user devices 904 and determine that the tag device 902 has been separated if more than a second separation threshold amount of time has elapsed. In some cases, the second separation threshold may be the same as, or different from the first separation threshold.

In some cases, a tag device 902 may determine that it has been separated form the user device 904 based on an estimated location. For example, the tag device 902 may be configured to determine the tag device 902 is separated if the tag device 902 is removed from certain defined geographic areas (e.g., geographic boundary). The tag device 902 may estimate whether the tag device 902 is within the defined geographic areas based on received signals, such as lost tag signals 908, and comparing the received signals to those signals known to be within the defined geographic area. For example, the tag device 902 may compare the identifiers from received lost tag signals 908 and compare those to stored identifiers of wireless nodes 910 that are associated with the defined geographic areas.

In some cases, certain information may be transmitted in the lost tag response 914. In some cases, the lost tag response 914 may include an encrypted owner's ID. The owner's ID may be associated with an account with the tag locating service under which the tag device 902 and user device 904 are registered. The owner's ID may be encrypted to help enhance privacy.

In some cases, the lost tag response 914 may include tag ID information. This tag ID information may include, for example, a public key or other shared key associated with the owner. For example, a public/private key may be created during a setup process for the tag device 902 and this public key may be used to encode information for the owner of the tag device that may be decoded using the private key of the owner. In some cases, the public key may be encrypted, for example, based on a key of the tag locating service.

In some cases, the lost tag response 914 may include an indication of a server address (e.g., URL, URI, and the like) associated with the tag locating service, such as a URL to a location tracking server 906. A device which receives the lost tag response 914 may forward information in the lost tag response 914 based on the indication server address. In some cases, the lost tag response 914 may also include a location request. The location request may indicate to a device which receives the lost tag response 914 that the tag device 902 is requesting that the receiving device estimate a location of the tag based on a location of the receiving device and forward the estimated location information to the location tracking server 906.

In some cases, the tag device 902 may transmit the lost tag response 914 using dedicated time/frequency resources, and these time/frequency resources may be preconfigured for the tag locating service. In some cases, the tag device 902 may transmit the lost tag response 914 using allocated time/frequency resources. For example, time/frequency resources may be dynamically configured by the wireless node 910 and/or the relay device 912. In some cases, a wireless node 910 may allow/disallow use of certain frequency resources, such as an unlicensed band, for the tag locating service.

In some cases, the allocation for the time/frequency resources may be included in the lost tag signal 908. In some cases, the tag device 902 may transmit the lost tag response 914 to the device which sent the lost tag signal 908. For example, if the wireless node 910 transmits the lost tag signal 908A, then the tag device 902 may transmit the lost tag response 914A to the wireless node 910. As another example, if the relay device 912 transmits the lost tag signal 908B, then the tag device may transmit the lost tag response 914B to the relay device 912. The relay device 912 may then relay 916 the lost tag response 914B, along with location information, if requested, to the wireless node 910. In some cases, the relay device 912 may relay 916 the lost tag response 914B to the location tracking server 906, for example, via a data connection through the wireless node 910.

In some cases, the tag device 902 may transmit the lost tag response 914 to a certain type of device, regardless of where the lost tag signal 908 (or energy signal) is received from. For example, the tag device 902 may receive the lost tag signal 908 (or energy signal) from either (or both) the wireless node 910 and/or relay device 912, and the tag device 902 may transmit the lost tag response 914B to the relay device 912. As another example, the tag device 902 may receive a lost tag signal 908A from the wireless node 910 along with an energy only signal from the relay device 912, and the tag device 902 may transmit the lost tag response 914B to the relay device 912. In some cases, lost tag signal 908 may indicate to which device the tag device 902 may transmit the lost tag response 914 to.

As indicated above, in some cases, the lost tag response 914 may include a location request requesting location information be sent to the location tracking server 906 along with information from the lost tag response 914. In some cases, based on the received location request, the relay device 912 and/or wireless node 910 may obtain location information associated with the tag device 902. In some cases, the location information may be the location of device receiving the location request (e.g., the relay device 912 and/or wireless node 910). In some cases, the location information may be provided through GNSS satellite based systems 918, such as GPS, GLONASS, GNSS, BDS, and the like. In some cases, the location information may be based, at least in part, on positioning technologies, such as received signal angle, triangulated positions, ranging, and the like. In some cases, the location information may be based on a location of the wireless node 910, a zone identifier associated with the wireless network, and the like. For example, a relay device 912 may transmit location information based on a wireless node 910 that the relay device 912 is connected to. In some cases, additional environmental information may also be provided, such as WiFi identifiers (e.g., BSSIDs of nearby WiFi access points), information associated with a vehicle mounted relay, such as a bus number, train number, and the like), or other similar environmental information that may be used to locate the tag device.

In some cases, common signaling may be used to trigger a tag device to send a lost tag signal, rather than dedicated signaling. For example, passive ZP IoT devices may harvest energy from an incoming energy signal that may be included with dedicated signaling, such as in lost tag signal 908. Semi-passive ZP IoT devices may extend the operations that may be performed by passive ZP-IoT devices to also include storing harvested energy. Thus, the semi-passive ZP IoT device may be able to harvest and store energy from other wireless transmissions without using a dedicated signaling, such as for an energy signal. Thus, for a tag locating service using semi-passive ZP IoT devices, common signaling (e.g., signaling that may be used to indicate other actions to other wireless devices) may be used in place of the lost tag signal 908. Examples of common signaling may include wake up signals, initial access signals, query commands, and the like. In some cases, the common signaling may be transmitted by either a wireless node 910 or a relay device 912. As an example, a semi-passive ZP IoT device may monitor wireless signals for a certain common signal, such as a wake-up command sent to the semi-passive ZP IoT devices, that may be transmitted by the wireless node 910. Based on the wake-up command, the semi-passive ZP IoT device may determine whether the device has been separated from the user device 904. In some cases, the common signal may include parameters discussed above with respect to the lost tag signal 908. In some cases, the semi-passive ZP IoT device may respond implicitly or explicitly to the common signal. For example, if the semi-passive ZP IoT device determines it has not been separated from the user device 904, then the semi-passive ZP IoT device may not respond to the wake-up command. If the semi-passive ZP IoT device determines it has been separated from the user device 904, then the semi-passive ZP IoT device may respond to the wake-up command. In some cases, the response to the wake-up command may include parameters discussed above with respect to the lost tag response 914. Aside from using the common signal rather than a dedicated signal such as the lost tag signal 908, the semi-passive ZP IoT device may operate in a manner substantially similar to that described above in conjunction with FIG. 9.

In some cases, the tag finding services may include techniques to help provide privacy for users and/or participants of the tag finding services. For example, measures make be taken to avoid revealing an identity associated with a tag device and to avoid potential tracking by monitoring signals transmitted from a tag or a user device. For example, the owner beacon transmitted from the user device 904 may be encrypted. As the owner beacon is encrypted, only tag devices associated with the user device 904 may be able to decrypt the owner beacon. In some cases, content of the owner beacon, such as an identifier for the user device 904 or other information may be changed periodically. For example, pseudo-random and/or random numbers may be added to the information in the owner beacon, which may change the encrypted owner beacon. In some cases, the encryption sequence for encrypting the owner beacon may be periodically changed.

In some cases, there may be a privacy concern regarding being tracked by an unknown tag device. To help address such concerns, a user device 904 may be configured to listen for lost tag responses 914 from tag devices. If a user device detects a lost tag response 914, the user device may log a time and/or location information related to the lost tag response. If another lost tag response is heard from the same tag multiple times in different locations, or if the lost tag responses are received in a certain pattern (e.g., periodically), then the user device may determine that the user device is being tracked and may display a warning prompt regarding the tag device.

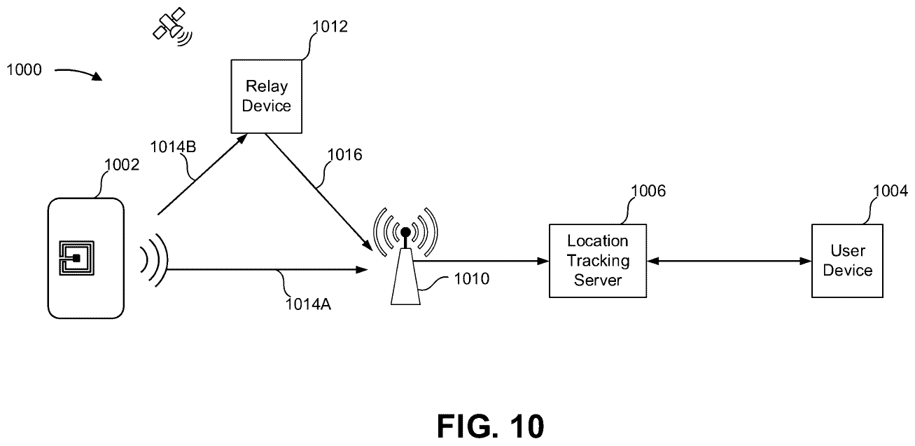

In some cases, detection that a tag device is separate from a user device may be performed by a server, such as location tracking server 906 of FIG. 9 or location tracking server 1006 of FIG. 10. Server side separation detection may be performed in place of, or in addition to a tag device determining that the tag device has been separated from the user device. In some cases, a server, such as a location tracking server, may detect whether a tag device is separated based on a reported time/location of the tag device and additional information. For example, a virtual fence or area of interest may be provided as the additional information and the server may determine whether the tag device is separated by comparing reported location of the tag device and the virtual fence/area of interest. If the tag device is outside of the virtual fence/area of interest, then the server may determine that the tag device has been separated (e.g., lost). As another example, in some cases, the tag device may report location information to the server and the server may monitors a time associated with the reported location information. If location information has not been received for a threshold amount of time, then the server may determine that the tag device has been separated. In some cases, the tag device and user device may report location information to the server. If the location between the tag device and user device exceeds a threshold distance, then the server may determine that the tag device has been separated. Additionally, if the tag device indicates that the tag device has not received the owners beacon for more than a threshold amount of time, the server may determine that the tag device has been separated. In some cases, if the server determines that the tag device has been separated, the server may send a notification of the separation to the user device.

FIG. 10 is a diagram illustrating finding 1000 an active ZP IoT device, in accordance with aspects of the present disclosure. In FIG. 10, an active ZP IoT device 1002 (hereinafter active tag device 1002) may be remote (e.g., attached to a lost/misplaced item) from a user device 1004. In some cases, an active ZP IoT device may differ from a (semi) passive ZP IoT device in that the active ZP IoT device includes a power source, such as a battery, which may be used to power the active ZP IoT device. The active tag device 1002 may then be able to process data, transmit, and/or receive without relying on an energizing transmission, such as the lost tag signal 908 of FIG. 8.

In some cases, an active tag device 1002 may determine that it has been separated from a user device 1004 in a manner substantially similar to that described above with respect to the tag device 902. Based on a determination that the active tag device 1002 has been separated, the active tag device 1002 may broadcast a lost beacon 1014A, 1014B (collectively referred to as a lost beacon 1014). In some cases, the lost beacon 1014 may be transmitted using L1, L2, or L3 signaling. In some cases, the lost beacon 1014 may use dedicated time/frequency resources, which may be preconfigured for tag locating service. In some cases, the lost beacon 1014 may use allocated time/frequency resources, which may be dynamically configured from the wireless node 1010 and/or relay device 1012. In some cases, the lost beacon 1014 may be broadcast based on a common signal in a manner substantially similar to that described above with respect to semi-passive ZP IoT devices.

In some cases, the lost beacon 1014 may include an encrypted owner's ID. The owner's ID may be encrypted to help enhance privacy and the owner's ID may only be decrypted by a location tracking server 1006. In some cases, the lost beacon 1014 may include tag ID information. This tag ID information may include, for example, a public key or other shared key associated with the owner. For example, a public/private key may be created during a setup process for the active tag device 1002 and this public key may be used to encode information for the owner of the tag device that may be decoded using the private key of the owner. In some cases, the public key may be encrypted, for example, based on a key of the tag locating service.

In some cases, the lost beacon 1014 may include an indication of a server address (e.g., URL, URI, and the like) associated with the tag locating service, such as a URL to a location tracking server 1006. A device which receives the lost beacon 1014 may forward information in the lost beacon 1014 based on the indication server address. In some cases, the lost beacon 1014 may also include a location request. The location request may indicate to a device which receives the lost beacon 1014 that the active tag device 1002 is requesting that the receiving device estimate a location of the tag based on a location of the receiving device and forward the estimated location information to the location tracking server 1006.

The lost beacon 1014 may be received by nearby relay devices 1012 and/or wireless nodes 1010. In some cases, the lost beacon 1014 may include a location request requesting location information be sent to the location tracking server 1006 along with information from the lost beacon 1014. The relay devices 1012 and/or wireless nodes 1010 may obtain the requested location information in a manner substantially similar to that described above with respect to FIG. 9. Where the relay device 1012 receives the lost beacon 1014, the relay device 1012 may relay 1016 the lost beacon 1014B, along with location information, if requested, to the wireless node 1010. In some cases, the relay device 1012 may relay 1016 the lost beacon 1014B to the location tracking server 1006, for example, via a data connection through the wireless node 1010. The wireless node 1010 may transmit the information from the lost beacon 1014, and location information if requested/attached, to the location tracking server 1006. A user device 1004 may then query the location tracking server to locate the active tag device 1002.

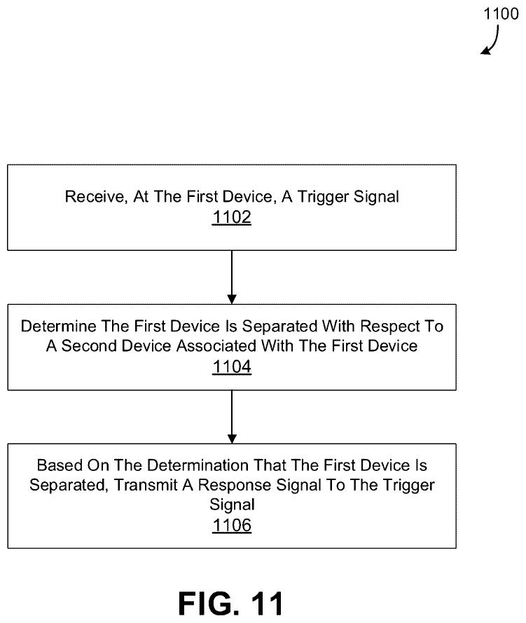

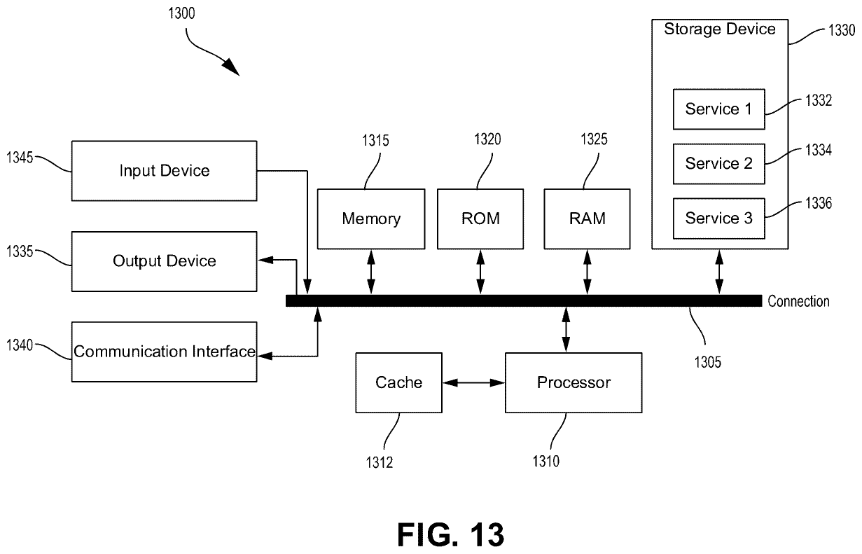

FIG. 11 is a flowchart diagram illustrating an example of a process 1100 for wireless communications. The process 1100 may be performed by a first device or by a component or system (e.g., a chipset) of the first device. The first device may be a ZP IoT device (e.g., radio frequency (RF) energy harvesting device 500 of FIG. 5, ZP IoT device 802, 852 of FIG. 8, ZP IoT device 902 of FIG. 9, or ZP IoT device 1002 of FIG. 10), a UE (e.g., a mobile device such as a mobile phone, a network-connected wearable such as a watch, an extended reality device such as a virtual reality (VR) device or augmented reality (AR) device, a vehicle or component or system of a vehicle, or other type of UE) or other type of network node. In some examples, the process 1100 may be performed by a UE and/or an energy harvesting device. In some cases, the UE can be an energy harvesting device. The operations of the process 1100 may be implemented as software components that are executed and run on one or more processors (e.g., processor 1310 of FIG. 13 or other processor(s)). Further, the transmission and reception of signals by the network device in the process 1100 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communication interface 1340 of FIG. 13, or other antennae(s), transceiver(s), and/or component(s)).

At block 1102, the first device (or component thereof) may receive, at the first device, a trigger signal. In some cases, the trigger signal is received with an energy signal. In aspects cases, the first device includes an energy harvester configured to harvest energy from the energy signal. In some cases, the trigger signal is transmitted to the first device by one of a wireless node or a relay device. In some examples, the first device (or component thereof) may receive a beacon. In some cases, the first device (or component thereof) may determine that an identifier in the beacon matches a stored identifier associated with the second device. In some aspects, the stored identifier is an identifier for a family device. In some cases, the trigger signal includes resource allocation information for the first device. In some examples, the response signal is transmitted based on the resource allocation information. In some cases, the trigger signal is one of a: periodic signal, aperiodic signal, or semi-periodic signal.

At block 1104, the first wireless device (or component thereof) may determine the first device is separated with respect to a second device associated with the first device. In some cases, the first device (or component thereof) may determine the first device is separated by determining that the beacon including the identifier of the second device has not been received within a threshold amount of time. In some cases, the first device (or component thereof) may determine the first device is separated by estimating a location of the first device. In some cases, the first device (or component thereof) may determine the first device is separated by comparing the estimated location with a defined geographic area to determine if the first device is outside of the defined geographic area.

At block 1106, the first wireless device (or component thereof) may, based on the determination that the first device is separated, transmit a response signal to the trigger signal. In some cases, the response signal includes at least one of: an encrypted identifier associated with the second device; and service address information for a device locating service. In some cases, the response signal includes a location request. In some cases, the response signal is transmitted to at least one of a wireless node or a relay device.

In some examples, the processes described herein (e.g., process 1100, and/or other process described herein) may be performed by a computing device or apparatus (e.g., a network node such as a UE, base station, a portion of a base station, etc.). For example, as noted above, one or more of the processes described herein (e.g., the process 1100, and/or other process described herein) may be performed by a UE and/or an energy harvesting device (e.g., an EH-capable device). In some examples, one or more of the processes described herein (e.g., the process 1100, and/or other process described herein) may be performed by an EH-capable device with an architecture that is the same as or similar to the EH-capable device architecture shown in FIG. 5.

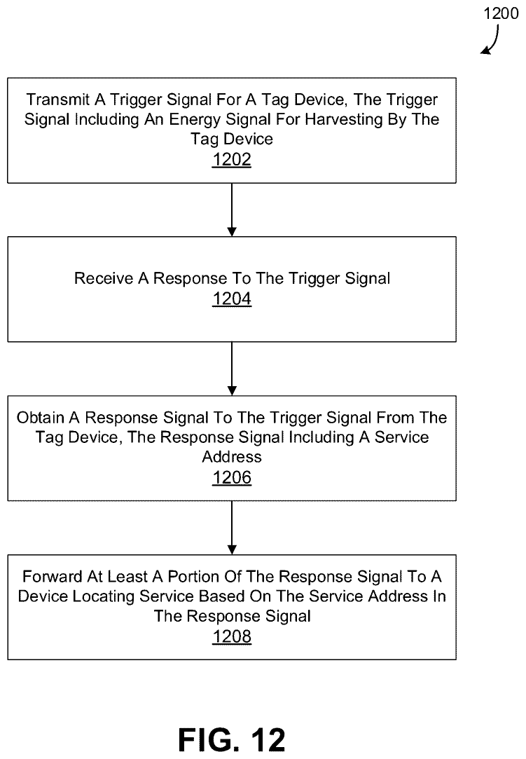

FIG. 12 is a flowchart diagram illustrating an example of a process 1200 for wireless communications. The process 1200 may be performed by a wireless device or by a component or system (e.g., a chipset) of the wireless device. The first wireless device may be a network node (e.g., base station 102, AP 150, or mmW BS 180 of FIG. 1, network node 806 of FIG. 8A, network node 860 of FIG. 8B, wireless node 910 of FIG. 9, or wireless node 1010 of FIG. 10), a UE (e.g., a mobile device such as a mobile phone, a network-connected wearable such as a watch, an extended reality device such as a virtual reality (VR) device or augmented reality (AR) device, a vehicle or component or system of a vehicle, or other type of UE), a relay device (e.g., relay device 912 of FIG. 9, relay device 1012 of FIG. 10), or other type of network node. In some examples, the process 1200 may be performed by a UE. The operations of the process 1200 may be implemented as software components that are executed and run on one or more processors (e.g., processor 1310 of FIG. 13 or other processor(s)). Further, the transmission and reception of signals by the network device in the process 1200 may be enabled, for example, by one or more antennas, one or more transceivers (e.g., wireless transceiver(s)), and/or other communication components (e.g., the transmit processor 220, the receive processor 238, the TX MIMO processor 230, the MIMO detector 236, the modulator(s)/demodulator(s) 232a through 232t, and/or the antenna(es) 234a through 234t of FIG. 2, the communication interface 1340 of FIG. 13, or other antennae(s), transceiver(s), and/or component(s)).

At block 1202, the wireless device (or component thereof) may transmit a trigger signal for a tag device (e.g., radio frequency (RF) energy harvesting device 500 of FIG. 5, ZP IoT device 802, 852 of FIG. 8, ZP IoT device 902 of FIG. 9, or ZP IoT device 1002 of FIG. 10). In some cases, the trigger signal includes an energy signal for harvesting by the tag device. In some cases, the device comprises a relay device (e.g., relay device 912 of FIG. 9, relay device 1012 of FIG. 10). In some cases, the wireless device (or component thereof) may forward at least a portion of the response signal to a device locating service by forwarding the response signal via a wireless network node. In some cases, the wireless device (or component thereof) may transmit the trigger signal by receiving one or more parameters for transmitting the trigger signal. In some cases, the wireless device (or component thereof) may transmit the trigger signal by transmitting the trigger signal based on the one or more parameters. In some cases, the one or more parameters include at least one of: an indication whether to transmit the trigger signal; a periodicity for the trigger signal; a time offset for the trigger signal; a time duration for transmitting the trigger signal; an indication of time and frequency resources for the trigger signal; and a transmit power scale factor for the trigger signal.

At block 1204, the wireless device (or component thereof) may receive a response to the trigger signal. In some cases, the response signal includes a location request. In some cases, the wireless device (or component thereof) may obtain location information associated with the tag device. In some cases, the wireless device (or component thereof) may transmit the location information to the device locating service. In some cases, the location information is obtained based on a location of a wireless node.

At block 1206, the wireless device (or component thereof) may obtain a response signal to the trigger signal from the tag device. In some cases, the response signal includes a service address.

At block 1208, the wireless device (or component thereof) may forward at least a portion of the response signal to a device locating service based on the service address in the response signal.

In some cases, the computing device or apparatus may include various components, such as one or more input devices, one or more output devices, one or more processors, one or more microprocessors, one or more microcomputers, one or more cameras, one or more sensors, and/or other component(s) that are configured to carry out the steps of processes described herein. In some examples, the computing device may include a display, one or more network interfaces configured to communicate and/or receive the data, any combination thereof, and/or other component(s). The one or more network interfaces may be configured to communicate and/or receive wired and/or wireless data, including data according to the 3G, 4G, 5G, and/or other cellular standard, data according to the WiFi (802.11x) standards, data according to the Bluetooth™ standard, data according to the Internet Protocol (IP) standard, and/or other types of data.

The components of the computing device may be implemented in circuitry. For example, the components may include and/or may be implemented using electronic circuits or other electronic hardware, which may include one or more programmable electronic circuits (e.g., microprocessors, graphics processing units (GPUs), digital signal processors (DSPs), central processing units (CPUs), and/or other suitable electronic circuits), and/or may include and/or be implemented using computer software, firmware, or any combination thereof, to perform the various operations described herein.

The process 1100 and the process 1200 are illustrated as a logical flow diagram, the operation of which represent a sequence of operations that may be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations may be combined in any order and/or in parallel to implement the processes.

Additionally, process 1100 and the process 1200, and/or other process described herein may be performed under the control of one or more computer systems configured with executable instructions and may be implemented as code (e.g., executable instructions, one or more computer programs, or one or more applications) executing collectively on one or more processors, by hardware, or combinations thereof. As noted above, the code may be stored on a computer-readable or machine-readable storage medium, for example, in the form of a computer program comprising a plurality of instructions executable by one or more processors. The computer-readable or machine-readable storage medium may be non-transitory.

FIG. 13 is a diagram illustrating an example of a system for implementing certain aspects of the present technology. In particular, FIG. 13 illustrates an example of computing system 1300, which may be for example any computing device making up internal computing system, a remote computing system, a camera, or any component thereof in which the components of the system are in communication with each other using connection 1305. Connection 1305 may be a physical connection using a bus, or a direct connection into processor 1310, such as in a chipset architecture. Connection 1305 may also be a virtual connection, networked connection, or logical connection.

In some aspects, computing system 1300 is a distributed system in which the functions described in this disclosure may be distributed within a datacenter, multiple data centers, a peer network, etc. In some aspects, one or more of the described system components represents many such components each performing some or all of the function for which the component is described. In some aspects, the components may be physical or virtual devices.

Example system 1300 includes at least one processing unit (CPU or processor) 1310 and connection 1305 that communicatively couples various system components including system memory 1325, such as read-only memory (ROM) 1320 and random access memory (RAM) 1325 to processor 1310. Computing system 1300 may include a cache 1315 of high-speed memory connected directly with, in close proximity to, or integrated as part of processor 1310.

Processor 1310 may include any general-purpose processor and a hardware service or software service, such as services 1332, 1334, and 1336 stored in storage device 1330, configured to control processor 1310 as well as a special-purpose processor where software instructions are incorporated into the actual processor design. Processor 1310 may essentially be a completely self-contained computing system, containing multiple cores or processors, a bus, memory controller, cache, etc. A multi-core processor may be symmetric or asymmetric.

To enable user interaction, computing system 1300 includes an input device 1345, which may represent any number of input mechanisms, such as a microphone for speech, a touch-sensitive screen for gesture or graphical input, key board, mouse, motion input, speech, etc. Computing system 1300 may also include output device 1335, which may be one or more of a number of output mechanisms. In some instances, multimodal systems may enable a user to provide multiple types of input/output to communicate with computing system 1300.

Computing system 1300 may include communications interface 1340, which may generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple™ Lightning™ port/plug, an Ethernet port/plug, a fiber optic port/plug, a proprietary wired port/plug, 3G, 4G, 5G and/or other cellular data network wireless signal transfer, a Bluetooth™ wireless signal transfer, a Bluetooth™ low energy (BLE) wireless signal transfer, an IBEACON™ wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1340 may also include one or more Global Navigation Satellite System (GNSS) receivers or transceivers that are used to determine a location of the computing system 1300 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 1330 may be a non-volatile and/or non-transitory and/or computer-readable memory device and may be a hard disk or other types of computer readable media which may store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (e.g., Level 1 (L1) cache, Level 2 (L2) cache, Level 3 (L3) cache, Level 4 (L4) cache, Level 5 (L5) cache, or other (L #) cache), resistive random-access memory (RRAM/ReRAM), phase change memory (PCM), spin transfer torque RAM (STT-RAM), another memory chip or cartridge, and/or a combination thereof.

The storage device 1330 may include software services, servers, services, etc., that when the code that defines such software is executed by the processor 1310, it causes the system to perform a function. In some aspects, a hardware service that performs a particular function may include the software component stored in a computer-readable medium in connection with the necessary hardware components, such as processor 1310, connection 1305, output device 1335, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data may be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted via any suitable means including memory sharing, message passing, token passing, network transmission, or the like.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks comprising devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules or components may be implemented together in an integrated logic device or separately as discrete but interoperable logic devices. If implemented in software, the techniques may be realized at least in part by a computer-readable data storage medium comprising program code including instructions that, when executed, performs one or more of the methods, algorithms, and/or operations described above. The computer-readable data storage medium may form part of a computer program product, which may include packaging materials. The computer-readable medium may comprise memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B.

Illustrative aspects of the disclosure include:

Aspect 1. A first device for wireless communication, comprising: at least one memory; and at least one processor coupled to the at least one memory, the at least one processor configured to: receive, at the first device, a trigger signal; determine the first device is separated with respect to a second device associated with the first device; and based on the determination that the first device is separated, transmit a response signal to the trigger signal.

Aspect 2. The first device of Aspect 1, wherein the trigger signal is received with an energy signal, and wherein the first device includes an energy harvester configured to harvest energy from the energy signal.

Aspect 3. The first device of any of Aspects 1-2, wherein the trigger signal is transmitted by one of a wireless node or a relay device.

Aspect 4. The first device of any of Aspects 1-3, wherein the at least one processor is further configured to: receive a beacon; and determine that an identifier in the beacon matches a stored identifier associated with the second device.

Aspect 5. The first device of Aspect 4, wherein, to determine the first device is separated, the at least one processor is configured to determine that the beacon including the identifier of the second device has not been received within a threshold amount of time.

Aspect 6. The first device of any of Aspects 4 or 5, wherein the stored identifier is an identifier for a family device.

Aspect 7. The first device of any of Aspects 1-6, wherein, to determine the first device is separated, the at least one processor is configured to: estimate a location of the first device; and compare the estimated location with a defined geographic area to determine if the first device is outside of the defined geographic area.

Aspect 8. The first device of any of Aspects 1-7, wherein the response signal includes at least one of: an encrypted identifier associated with the second device; and service address information for a device locating service.

Aspect 9. The first device of any of Aspects 1-8, wherein the response signal includes a location request.

Aspect 10. The first device of any of Aspects 1-9, wherein the response signal is transmitted to at least one of a wireless node or a relay device.

Aspect 11. The first device of any of Aspects 1-10, wherein the trigger signal includes resource allocation information for the first device, and wherein the response signal is transmitted based on the resource allocation information.

Aspect 12. The first device of any of Aspects 1-11, wherein the trigger signal is one of a: periodic signal, aperiodic signal, or semi-periodic signal.

Aspect 13. A device for wireless communications, comprising: at least one memory; and at least one processor coupled to the at least one memory, the at least one processor configured to: transmit a trigger signal for a tag device, the trigger signal including an energy signal for harvesting by the tag device: receive a response to the trigger signal; obtain a response signal to the trigger signal from the tag device, the response signal including a service address; and forward at least a portion of the response signal to a device locating service based on the service address in the response signal.

Aspect 14. The device of Aspect 13, wherein the device comprises a relay device, and wherein, to forward at least a portion of the response signal to a device locating service, the at least one processor is further configured to forward the response signal via a wireless network node.

Aspect 15. The device of any of Aspects 13-14, wherein, to transmit the trigger signal, the at least one processor is further configured to: receive one or more parameters for transmitting the trigger signal; and transmit the trigger signal based on the one or more parameters.

Aspect 16. The device of Aspect 15, wherein the one or more parameters include at least one of: an indication whether to transmit the trigger signal; a periodicity for the trigger signal; a time offset for the trigger signal; a time duration for transmitting the trigger signal; an indication of time and frequency resources for the trigger signal; and a transmit power scale factor for the trigger signal.

Aspect 17. The device of any of Aspects 13-16, wherein the response signal includes a location request, and wherein the at least one processor is further configured to: obtain location information associated with the tag device; and transmit the location information to the device locating service.

Aspect 18. The device of Aspect 17, wherein the location information is obtained based on a location of a wireless node.

Aspect 19. A method for wireless communications, comprising: receiving, at a first device, a trigger signal; determining the first device is separated with respect to a second device associated with the first device; and based on the determination that the first device is separated, transmitting a response signal to the trigger signal.

Aspect 20. The method of Aspect 19, wherein the trigger signal is received with an energy signal, and wherein the first device includes an energy harvester configured to harvest energy from the energy signal.

Aspect 21. The method of any of Aspects 19-20, wherein the trigger signal is transmitted by one of a wireless node or a relay device.

Aspect 22. The method of any of Aspects 19-21, further comprising: receiving a beacon; and determining that an identifier in the beacon matches a stored identifier associated with the second device.

Aspect 23. The method of Aspect 22, wherein determining the first device is separated comprises determining that the beacon including the identifier of the second device has not been received within a threshold amount of time.

Aspect 24. The method of any of Aspects 22 or 23, wherein the stored identifier is an identifier for a family device.

Aspect 25. The method of any of Aspects 19 to 24, wherein determining the first device is separated comprises: estimating a location of the first device; and comparing the estimated location with a defined geographic area to determine if the first device is outside of the defined geographic area.

Aspect 26. The method of any of Aspects 19-25, wherein the response signal includes at least one of: an encrypted identifier associated with the second device; and service address information for a device locating service.

Aspect 27. The method of any of Aspects 19-26, wherein the response signal includes a location request.

Aspect 28. The method of any of Aspects 19-26, wherein the response signal is transmitted to at least one of a wireless node or a relay device.

Aspect 29. The method of any of Aspects 19-26, wherein the trigger signal includes resource allocation information for the first device, and wherein the response signal is transmitted based on the resource allocation information.

Aspect 30. A method for wireless communications, comprising: transmitting a trigger signal for a tag device, the trigger signal including an energy signal for harvesting by the tag device: receiving a response to the trigger signal; obtaining a response signal to the trigger signal from the tag device, the response signal including a service address; and forwarding at least a portion of the response signal to a device locating service based on the service address in the response signal.

Aspect 31. The method of Aspect 30, wherein forwarding at least a portion of the response signal to a device locating service comprises forwarding the response signal via a wireless network node.

Aspect 32. The method of any of Aspects 30-31, wherein transmitting the trigger signal comprises: receiving one or more parameters for transmitting the trigger signal; and transmitting the trigger signal based on the one or more parameters.

Aspect 33. The method of Aspect 32, wherein the one or more parameters include at least one of: an indication whether to transmit the trigger signal; a periodicity for the trigger signal; a time offset for the trigger signal; a time duration for transmitting the trigger signal; an indication of time and frequency resources for the trigger signal; and a transmit power scale factor for the trigger signal.

Aspect 34. The method of any of Aspects 30-33, wherein the response signal includes a location request, and wherein the method further comprises: obtaining location information associated with the tag device; and transmitting the location information to the device locating service.

Aspect 35. The method of Aspect 34, wherein the location information is obtained based on a location of a wireless node.

Aspect 36. A non-transitory computer-readable medium having stored thereon instructions that, when executed by at least one processor, cause the at least one processor to: receive, at a first device, a trigger signal; determine the first device is separated with respect to a second device associated with the first device; and based on the determination that the first device is separated, transmit a response signal to the trigger signal.

Aspect 37. The non-transitory computer-readable medium of Aspect 36, wherein the trigger signal is received with an energy signal, and wherein the first device includes an energy harvester configured to harvest energy from the energy signal.

Aspect 38. The non-transitory computer-readable medium of any of Aspects 36-37, wherein the trigger signal is transmitted by one of a wireless node or a relay device.

Aspect 39. The non-transitory computer-readable medium of any of Aspects 36-38, wherein the instructions cause the at least one processor: receive a beacon; and determine that an identifier in the beacon matches a stored identifier associated with the second device.

Aspect 40. The non-transitory computer-readable medium of Aspect 39, wherein, to determine the first device is separated, the instructions cause the at least one processor to determine that the beacon including the identifier of the second device has not been received within a threshold amount of time.

Aspect 41. The non-transitory computer-readable medium of any of Aspects 39 or 40, wherein the stored identifier is an identifier for a family device.

Aspect 42. The non-transitory computer-readable medium of any of Aspects 36-41, wherein, to determine the first device is separated, the instructions cause the at least one processor to: estimate a location of the first device; and compare the estimated location with a defined geographic area to determine if the first device is outside of the defined geographic area.

Aspect 43. The non-transitory computer-readable medium of any of Aspects 36-42, wherein the response signal includes at least one of: an encrypted identifier associated with the second device; and service address information for a device locating service.

Aspect 44. The non-transitory computer-readable medium of any of Aspects 36-43, wherein the response signal includes a location request.

Aspect 45. The non-transitory computer-readable medium of any of Aspects 36-44, wherein the response signal is transmitted to at least one of a wireless node or a relay device.

Aspect 46. The non-transitory computer-readable medium of any of Aspects 36-45, wherein the trigger signal includes resource allocation information for the first device, and wherein the response signal is transmitted based on the resource allocation information.

Aspect 47. The non-transitory computer-readable medium of any of Aspects 36-46, wherein the trigger signal is one of a: periodic signal, aperiodic signal, or semi-periodic signal.

Aspect 48. A non-transitory computer-readable medium of a device, the non-transitory computer-readable medium having stored thereon instructions that, when executed by at least one processor, cause the at least one processor to: transmit a trigger signal for a tag device, the trigger signal including an energy signal for harvesting by the tag device: receive a response to the trigger signal; obtain a response signal to the trigger signal from the tag device, the response signal including a service address; and forward at least a portion of the response signal to a device locating service based on the service address in the response signal.

Aspect 49. The non-transitory computer-readable medium of Aspect 48, wherein the device comprises a relay device, and wherein, to forward at least a portion of the response signal to a device locating service, the at least one processor is further configured to forward the response signal via a wireless network node.

Aspect 50. The non-transitory computer-readable medium of any of Aspects 48-49, wherein, to transmit the trigger signal, the instructions cause the at least one processor to: receive one or more parameters for transmitting the trigger signal; and transmit the trigger signal based on the one or more parameters.

Aspect 51. The non-transitory computer-readable medium of Aspect 50, wherein the one or more parameters include at least one of: an indication whether to transmit the trigger signal; a periodicity for the trigger signal; a time offset for the trigger signal; a time duration for transmitting the trigger signal; an indication of time and frequency resources for the trigger signal; and a transmit power scale factor for the trigger signal.

Aspect 52. The non-transitory computer-readable medium of any of Aspects 48-51, wherein the response signal includes a location request, and wherein the instructions cause the at least one processor to: obtain location information associated with the tag device; and transmit the location information to the device locating service.

Aspect 53. The non-transitory computer-readable medium of Aspect 52, wherein the location information is obtained based on a location of a wireless node.

Aspect 54. An apparatus for wireless communications, comprising one or more means for performing operations according to any of Aspects 19 to 35.

1. A first device for wireless communication, comprising:
at least one memory; and
at least one processor coupled to the at least one memory, the at least one processor configured to:
receive, at the first device, a trigger signal;
determine the first device is separated with respect to a second device associated with the first device; and
based on the determination that the first device is separated, transmit a response signal to the trigger signal.

2. The first device of claim 1, wherein the trigger signal is received with an energy signal, and wherein the first device includes an energy harvester configured to harvest energy from the energy signal.

3. The first device of claim 1, wherein the trigger signal is transmitted by one of a wireless node or a relay device.

4. The first device of claim 1, wherein the at least one processor is further configured to:
receive a beacon; and
determine that an identifier in the beacon matches a stored identifier associated with the second device.

5. The first device of claim 4, wherein, to determine the first device is separated, the at least one processor is configured to determine that the beacon including the identifier of the second device has not been received within a threshold amount of time.

6. The first device of claim 4, wherein the stored identifier is an identifier for a family device.

7. The first device of claim 1, wherein, to determine the first device is separated, the at least one processor is configured to:
estimate a location of the first device; and
compare the estimated location with a defined geographic area to determine if the first device is outside of the defined geographic area.

8. The first device of claim 1, wherein the response signal includes at least one of:
an encrypted identifier associated with the second device; and
service address information for a device locating service.

9. The first device of claim 1, wherein the response signal includes a location request.

10. The first device of claim 1, wherein the response signal is transmitted to at least one of a wireless node or a relay device.

11. The first device of claim 1, wherein the trigger signal includes resource allocation information for the first device, and wherein the response signal is transmitted based on the resource allocation information.

12. The first device of claim 1, wherein the trigger signal is one of a:
periodic signal,
aperiodic signal, or
semi-periodic signal.

13. A device for wireless communications, comprising:
at least one memory; and
at least one processor coupled to the at least one memory, the at least one processor configured to:
transmit a trigger signal for a tag device, the trigger signal including an energy signal for harvesting by the tag device;
receive a response to the trigger signal;
obtain a response signal to the trigger signal from the tag device, the response signal including a service address; and
forward at least a portion of the response signal to a device locating service based on the service address in the response signal.

14. The device of claim 13, wherein the device comprises a relay device, and wherein, to forward at least a portion of the response signal to a device locating service, the at least one processor is further configured to forward the response signal via a wireless network node.

15. The device of claim 13, wherein, to transmit the trigger signal, the at least one processor is further configured to:
receive one or more parameters for transmitting the trigger signal; and
transmit the trigger signal based on the one or more parameters.

16. The device of claim 15, wherein the one or more parameters include at least one of:
an indication whether to transmit the trigger signal;
a periodicity for the trigger signal;
a time offset for the trigger signal;
a time duration for transmitting the trigger signal;
an indication of time and frequency resources for the trigger signal; and
a transmit power scale factor for the trigger signal.

17. The device of claim 13, wherein the response signal includes a location request, and wherein the at least one processor is further configured to:
obtain location information associated with the tag device; and
transmit the location information to the device locating service.

18. The device of claim 17, wherein the location information is obtained based on a location of a wireless node.

19. A method for wireless communications, comprising:
receiving, at a first device, a trigger signal;
determining the first device is separated with respect to a second device associated with the first device; and
based on the determination that the first device is separated, transmitting a response signal to the trigger signal.

20. The method of claim 19, wherein the trigger signal is received with an energy signal, and wherein the first device includes an energy harvester configured to harvest energy from the energy signal.

21. The method of claim 19, wherein the trigger signal is transmitted by one of a wireless node or a relay device.

22. The method of claim 19, further comprising:
receiving a beacon; and
determining that an identifier in the beacon matches a stored identifier associated with the second device.

23. The method of claim 22, wherein determining the first device is separated comprises determining that the beacon including the identifier of the second device has not been received within a threshold amount of time.

24. The method of claim 22, wherein the stored identifier is an identifier for a family device.

25. The method of claim 22, wherein determining the first device is separated comprises:
estimating a location of the first device; and
comparing the estimated location with a defined geographic area to determine if the first device is outside of the defined geographic area.

26. The method of claim 19, wherein the response signal includes at least one of:
an encrypted identifier associated with the second device; and
service address information for a device locating service.

27. The method of claim 19, wherein the response signal includes a location request.

28. The method of claim 19, wherein the response signal is transmitted to at least one of a wireless node or a relay device.

29. The method of claim 19, wherein the trigger signal includes resource allocation information for the first device, and wherein the response signal is transmitted based on the resource allocation information.

30. A method for wireless communications, comprising:
transmitting a trigger signal for a tag device, the trigger signal including an energy signal for harvesting by the tag device;
receiving a response to the trigger signal;
obtaining a response signal to the trigger signal from the tag device, the response signal including a service address; and
forwarding at least a portion of the response signal to a device locating service based on the service address in the response signal.

31. The method of claim 30, wherein forwarding at least a portion of the response signal to a device locating service comprises forwarding the response signal via a wireless network node.

32. The method of claim 30, wherein transmitting the trigger signal comprises:
receiving one or more parameters for transmitting the trigger signal; and
transmitting the trigger signal based on the one or more parameters.

33. The method of claim 32, wherein the one or more parameters include at least one of:
an indication whether to transmit the trigger signal;
a periodicity for the trigger signal;
a time offset for the trigger signal;
a time duration for transmitting the trigger signal;
an indication of time and frequency resources for the trigger signal; and
a transmit power scale factor for the trigger signal.

34. The method of claim 30, wherein the response signal includes a location request, and wherein the method further comprises:
obtaining location information associated with the tag device; and
transmitting the location information to the device locating service.

35. The method of claim 34, wherein the location information is obtained based on a location of a wireless node.

36.-53. (canceled)
